(19) United States
(12) Patent Application Publication
(10) Pub. No.: US 2024/0346735 A1
(43) Pub. Date: Oct. 17, 2024

(54) SYSTEM AND METHOD FOR GENERATING VIDEOS DEPICTING VIRTUAL CHARACTERS

(71) Applicant: University of Rochester, Rochester, NY (US)

(72) Inventors: Luchuan Song, Buffalo, NY (US); Chenliang Xu, Pittsford, NY (US)

(21) Appl. No.: 18/633,750

(22) Filed: Apr. 12, 2024

Related U.S. Application Data
(60) Provisional application No. 63/459,144, filed on Apr. 13, 2023.

(51) Int. Cl. G06T 13/40; G06T 3/18; G06T 7/20; G06T 7/70; G06T 17/20; G06V 10/44; G06V 40/16; H04N 21/81

(52) U.S. Cl. CPC G06T 13/40; G06T 3/18; G06T 7/20; G06T 7/70; G06T 17/20; G06V 10/44; G06V 40/174; H04N 21/816

(57) ABSTRACT

Features described herein pertain to generative machine learning, and more particularly, to machine learning techniques for generating virtual characters. A video that depicts a first subject and includes an audio component that corresponds to speech spoken by the first subject and an image that depicts a second subject are provided to and used by one or more machine learning models to generate a video that depicts the second subject. The second subject can blink and exhibit emotional characteristic and reactions that are responsive to the speech spoken by the first subject and/or a characteristic of the first subject such as a facial expression and/or head pose motion. The generated video can be displayed and/or stored where it can be later retrieved.

### CROSS-REFERENCE TO RELATED APPLICATIONS

The present application is a non-provisional application of and claims the benefit and priority to U.S. Provisional Application No. 63/459,144, filed Apr. 13, 2023, the entire contents of which is incorporated herein by reference for all purposes.

### FIELD

This disclosure generally relates to generative machine learning. More specifically, but not by way of limitation, this disclosure relates to machine learning techniques for generating videos depicting virtual characters.

### BACKGROUND

As chatbots, the metaverse, virtual reality, and other human-computer interaction technologies become prevalent, users have become accustomed to interacting with each other virtually. Users are often represented virtually with a virtual character such as an avatar. In some cases, a virtual character can be generated based on features of a human user that the virtual character represents. For example, a human user's behavior in the real-world can be mimicked by an avatar in the virtual world. In other cases, a virtual character can be generated based on features of a virtual user that the virtual character represents. For example, a virtual user's behavior in a virtual world can be represented by an avatar in the virtual world.

### SUMMARY

Embodiments described herein pertain to generative machine learning, and more particularly, to machine learning techniques for generating videos depicting virtual characters.

In various embodiments, a computer-implemented method includes accessing, by a processor of a computing device, a first video depicting a first subject, wherein the first video includes an audio component that corresponds to speech spoken by the first subject; accessing, by the processor, an image depicting a second subject; providing, by the processor, the first video and the image to one or more machine learning models; generating, by the processor and using the one or more machine learning models, a second video depicting the second subject, wherein the second video depicts the second subject performing a blinking motion, and wherein the blinking motion performed by the second subject is responsive to at least one of the speech spoken by the first subject, a facial expression of the first subject, and a head pose motion of the first subject; and storing, by the processor, the second video on a storage device.

In some embodiments, generating the second video includes generating, by the processor and based on the first video, a plurality of feature vectors representing visual features and speech features of the first subject.

In some embodiments, generating the second video further includes generating, by the processor and based on the plurality of feature vectors, an emotion vector representing one or more emotional characteristics of the first subject.

In some embodiments, generating the second video further includes generating, by the processor and based on the plurality of feature vectors and the emotion vector, a discrete latent space, the discrete latent space representing one or more motion characteristics of the second subject.

In some embodiments, generating the second video further includes generating, by the processor and based on the discrete latent space, a sequence of blink coefficients representing blinking performed by the first subject.

In some embodiments, generating the second video further includes generating, by the processor and based on the image, a mesh of the second subject, and the sequence of blink coefficients, the second video.

In some embodiments, the method further includes retrieving, by the processor, the second video from the storage device; and displaying, by the processor, the second video on a display.

In various embodiments, a computer-implemented method includes accessing, by a processor, plurality of videos and a plurality of images; generating, by the processor, a first feature vector from at least one video of the plurality of videos, the first feature vector representing one or more visual features of the at least one video; generating, by the processor, a second feature vector from the at least one video, the second feature vector representing one or more audio features of the at least one video; combining, by the processor, the first feature vector with the second feature vector, the combination of the first feature vector and the second feature vector representing a continuous latent space for the at least one video; mapping, by the processor, the continuous latent space to a discrete latent space, the discrete latent space representing one or more motion characteristics of a subject; decoding, by the processor, the discrete latent space into a plurality of coefficients; and generating, by the processor, an avatar based on the plurality of coefficients, the avatar comprising a sequence of frames depicting the subject and an emotional reaction of the subject.

In some embodiments, the one or more visual features of the at least one video includes a facial expression or motion of a subject of the at least one video.

In some embodiments, the one or more audio features of the at least one video includes speech made by a subject of the at least one video.

In some embodiments, mapping the continuous latent space to the discrete latent space includes dividing the continuous latent space into a plurality of segments, encoding each segment of the plurality of segments, and mapping each encoded segment into a discrete representation of the discrete latent space.

In some embodiments, the method further includes combining, by the processor, a third feature vector with the discrete latent space, wherein the third feature vector represents an emotional characteristic of a subject of the at least one video.

In some embodiments, decoding the discrete latent space into the plurality of coefficients includes decoding one or more geometrical features of at least one image of the plurality of images.

In some embodiments, generating the avatar based on the plurality of coefficients includes warping at least one image of the plurality of images.

In some embodiments, generating the avatar includes controlling a blinking rate of the subject.

Some embodiments include a system including one or more processors and one or more computer-readable media storing instructions which, when executed by the one or more processors, cause the system to perform part or all the operations and/or methods disclosed herein.

Some embodiments include one or more non-transitory computer-readable media storing instructions which, when executed by one or more processors, cause a system to perform part or all the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a pipeline for generating a video depicting a virtual character according to some implementations of the present disclosure.

FIG. 2 illustrates an example of a virtual character generation system according to some implementations of the present disclosure.

FIG. 3 illustrates an example of a feature extraction stage of a flow for generating videos depicting virtual characters according to some implementations of the present disclosure.

FIG. 4A illustrates an example of an adaptive space encoding stage of the flow for generating videos depicting virtual characters according to some implementations of the present disclosure.

FIG. 4B illustrates an example of a flow for processing a base space into a discrete latent space according to some implementations of the present disclosure.

FIG. 5 illustrates an example of a rendering stage of the flow for generating videos depicting virtual characters according to some implementations of the present disclosure.

FIG. 6 illustrates an example of an avatar generation system according to some implementations of the present disclosure.

FIG. 7 is a simplified block diagram of a reactor according to some implementations of the present disclosure.

FIG. 8 is a simplified block diagram of a trainer according to some implementations of the present disclosure.

FIG. 9 is a simplified block diagram of a renderer according to some implementations of the present disclosure.

FIG. 10 illustrates an example of a process for generating a video depicting a virtual character according to some implementations of the present disclosure.

FIG. 11 illustrates an example process for generating an avatar according to some implementations of the present disclosure.

### DETAILED DESCRIPTION

Virtual characters such as avatars and virtual humans have proven to be useful for enabling human-computer interaction. For example, in virtual worlds such as the metaverse, virtual characters representing real users or virtual users interact with each other, conduct transactions, and even have relationships. In various industries such as intelligent customer service and online education, people often interact with each other using virtual characters. In some cases, virtual characters enable human and virtual users to interact with each other in the real-world and in virtual worlds. For example, human gamers interacting with gaming applications in the real-world have found it convenient to interact with other human gamers or virtual gamers in a virtual world. Similarly, human participants in virtual conversations facilitated by chatbots and messaging applications have found it enjoyable to interact with other human or virtual participants in the virtual conversation. Often users have come to expect these virtual characters to be active and participate in the interaction. For example, users expect virtual characters that are speaking to exhibit the kinds of motion and expressions that a human would exhibit while speaking. Similarly, users expect virtual characters that are listening to be active listeners and react physically and emotionally to the speaker. Additionally, users expect virtual characters that are listening to exhibit emotion and facial expressions and move in ways that appear to be responsive towards the speaker. For example, a virtual character that appears to be listening to a speaker would be expected to have a facial expression and move in ways that exhibit positive emotions when the speaker shares something positive and/or happy.

For a virtual character that appears to be listening to a speaker to be considered natural and/or realistic, the virtual character should appear to exhibit an emotional reaction that is responsive to the speaker and/or any speech spoken by the speaker. For example, the virtual character should exhibit facial expressions and eye blinks and move in ways that are indicative of an emotional reaction. However, conventional solutions for generating virtual characters that are responsive to speakers tend to ignore these features. Often, the conventional methods generate virtual characters that just replicate the motion of the speaker instead of being responsive to the speaker or exhibiting an emotional reaction in response to speech spoken by the speaker and/or generate virtual characters with facial expressions that are not commensurate with the speech spoken by the speaker (e.g., a virtual character that is smiling in response to negative news spoken by the speaker). As a result, virtual characters generated using the conventional methods lack the verisimilitude of human communication and are not realistic.

The techniques described herein overcome these challenges and others by providing machine learning techniques for generating videos depicting virtual characters. Particularly, the virtual characters generated using the techniques described herein exhibit emotional reactions and other characteristics, including eye blinks, that are responsive to speakers and/or speech spoken the speakers. The developed approach begins with accessing a video that depicts a first subject and includes an audio component that corresponds to speech spoken by the first subject and accessing an image that depicts a second subject. The video and image are provided to one or more machine learning models that are used to generate a video that depicts the second subject. The second subject can blink and exhibit emotional characteristic and reactions that are responsive to the speech spoken by the first subject and/or a characteristic of the first subject such as a facial expression and/or head pose motion of the first subject. The generated video can be displayed and/or stored where it can be later retrieved for viewing.

The foregoing illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

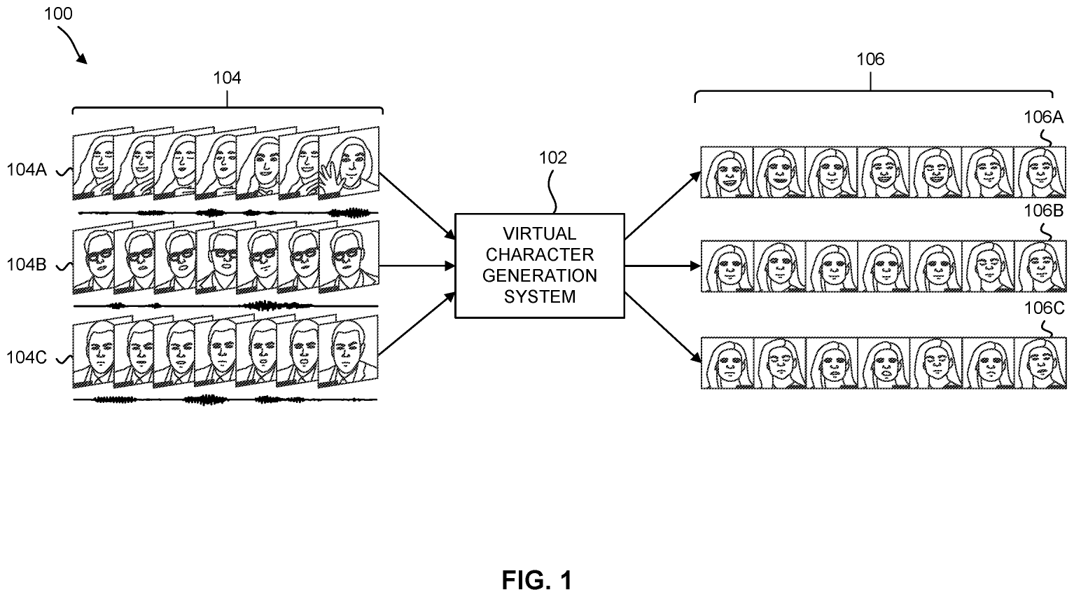

FIG. 1 illustrates an example of a pipeline for generating a video depicting a virtual character. As shown in the FIG. 1, the pipeline 100 includes a virtual character generation system 102 that is configured to generate listener videos 106 that depict virtual characters based on speaker videos 104 provided to the virtual character generation system 102.

The speaker videos 104 provided to the virtual character generation system 102 can depict real-world or virtual people that are speaking. In some implementations, the speaker videos 104 depict real-world people or virtual characters speaking on topic that is emotional and/or can invoke an emotion in a listener. For example, the speaker videos 104 can include one or more speaker videos 104A that depict a person speaking on a topic that is positive and/or can invoke a positive emotion in a listener, one or more speaker videos 104B that depict a person speaking on a topic that is negative and/or can invoke a negative emotion in a listener, and one or more speaker videos 104C that depict a person speaking on a topic that is neutral and/or can invoke a neutral emotion in a listener.

The listener videos 106 generated by the virtual character generation system 102 can depict virtual characters that appear to be listening to speakers such as those depicted by the speaker videos 104. In some implementations, the virtual characters depicted by the listener videos 106 appear to exhibit one or more emotions (e.g., by exhibiting motions, facial expressions, and/or eye blinks representative of one or more emotions) as if they are listening to a speaker that is speaking on a topic that is emotional and/or can invoke an emotion in a listener. For example, the listener videos 106 can include one or more listener videos 106A that depict a virtual character appearing to listen to a speaker that is speaking on a topic that is emotionally positive and/or can invoke a positive emotion in a listener, one or more listener videos 106B that depict a virtual character appearing to listen to a speaker that is speaking on a topic that is emotionally negative and/or can invoke a negative emotion in a listener, and one or more listener videos 106C that depict a virtual character appearing to listen to a speaker that is speaking on a topic that is emotionally neutral and/or can invoke a neutral emotion in a listener.

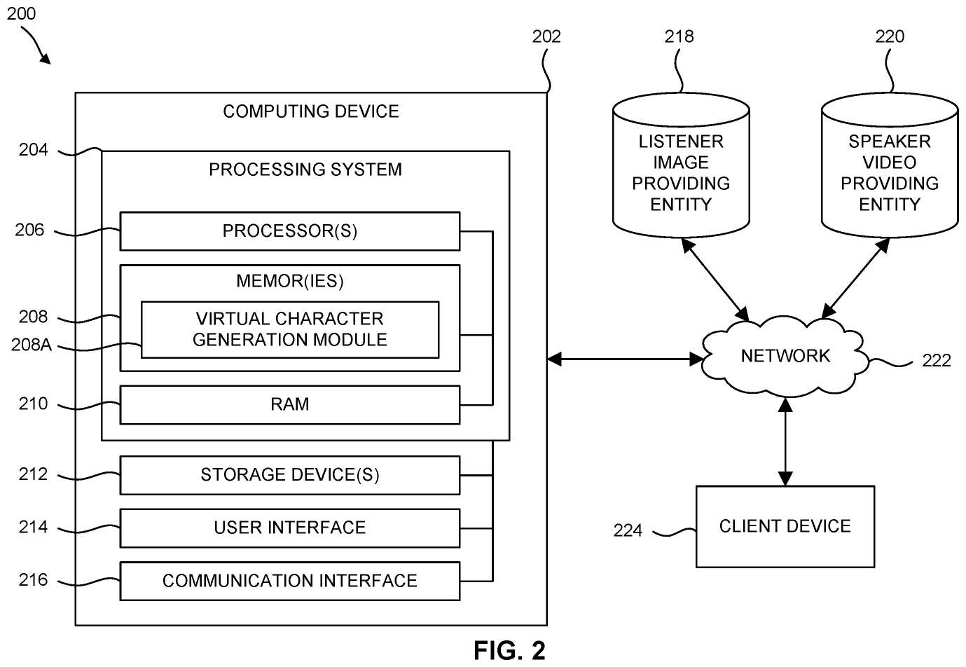

FIG. 2 illustrates an example of a virtual character generation system. As shown in FIG. 2, the virtual character generation system 200 (hereinafter “system 200”) includes a computing device 202, a listener image providing entity 218, a speaker video providing entity 220, a network 222, and a client device 224. The computing device 202, listener image providing entity 218, speaker video providing entity 220, and client device 224 can be in communication with each other via the network 222, which can be any kind of network, including one or more, public, private, wired, and/or wireless networks, that can facilitate communications among components of the system 200.

The computing device 202 includes a processing system 204, one or more storage devices 212, a user interface 214, and a communication interface 216. The computing device 202 can be implemented in various configurations in order to provide various functionality. For example, the computing device 202 can be implemented as a portable electronic or communication device such as a smartphone, a wearable device, a tablet, and the like. The foregoing is not intended to be limiting and the computing device 202 can be implemented as any kind of electronic device that can be configured to generate a video depicting virtual character using a part of or all the processing, operations, and/or methods disclosed herein.

The processing system 204 includes one or more processors 206, one or more memories 208, and RAM 210. The one or more processors 206 can read one or more programs from the one or more memories 208 and execute them using RAM 210. Each of the one or more processors 206 can be of any type including but not limited to a microprocessor, a microcontroller, a graphical processing unit, a digital signal processor, an application-specific integrated circuit (ASIC), a field programmable gate array (FPGA), or any combination thereof. In some implementations, the one or more processors 206 can include a plurality of cores, a plurality of arrays, one or more coprocessors, and/or one or more layers of local cache memory. The one or more processors 206 can execute one or more programs stored in the one or more memories 208 to perform the processing, operations, and/or methods, including parts thereof, described herein.

Each of the one or more memories 208 can be non-volatile and can include any type of memory device that retains stored information when powered off. Non-limiting examples of memory include electrically erasable and programmable read-only memory (EEPROM), flash memory, or any other type of non-volatile memory. At least one memory of the one or more memories 208 can include a non-transitory computer-readable storage medium from which the one or more processors 206 can read instructions. A computer-readable storage medium can include electronic, optical, magnetic, or other storage devices capable of providing the one or more processors 206 with computer-readable instructions or other program code. Non-limiting examples of a computer-readable storage medium include magnetic disks, memory chips, read-only memory (ROM), RAM, an ASIC, a configured processor, optical storage, or any other medium from which a computer processor can read the instructions.

The virtual character generation module 208A can be configured to generate videos depicting virtual characters in accordance with the processing, operations, and/or methods, including parts thereof, described herein. In some implementations, to generate a video depicting a virtual character, the virtual character generation module 208A can be configured to acquire a speaker video from the speaker video providing entity 220, extract features of the speaker video (e.g., in a feature extraction stage), transform the features into sets/sequences of coefficients (e.g., in an adaptive space encoding stage), and generate a listener video depicting a virtual character from the sets/sequences of coefficients for the speaker video and coefficients derived from a listener image acquired from the listener image providing entity 218 (e.g., in a rendering stage).

The speaker video can depict a person, subject, or character (e.g., a real-world or virtual person or character) that is speaking and include audio content corresponding to speech spoken by the person or character speaking. For example, a speaker video received from the speaker video providing entity 220 can be a video of a person speaking and the audio content of the video can be the person's speech. The speaker video can depict real-world or virtual people that are speaking. In some implementations, the person, subject, or character can have one or more emotional states or characteristics and/or represent one or more emotional states or characteristics (e.g., particular facial expression or expressions; blink randomly or pseudo-randomly or at a particular blinking pattern, frequency, rate; perform particular head motions, and the like). In some implementations, the speaker videos can depict real-world people or virtual characters speaking on topic that is emotional and/or can invoke an emotion in a listener. For example, the speaker video can depict a person speaking on a topic that is positive and/or can invoke a positive emotion in a listener, a topic that is negative and/or can invoke a negative emotion in a listener, a topic that is neutral and/or can invoke a neutral emotion in a listener.

The listener image can depict a person, subject, or character (e.g., real-world or virtual person or character) that will form the basis of the listener video. The person, subject, or character can be the same as or different from the person, subject, or character of the speaker video. The listener video can depict the person, subject, or character of the listener image exhibiting an emotional reaction, including eye blinks, that is responsive to the person or character speaking and/or the speech spoken by the person or character speaking.

In some implementations, the person, subject, or character (hereinafter “virtual character”) depicted by the videos generated by the virtual character generation module 208A can exhibit lifelike motions, facial expressions, emotions, reactions, behaviors, and/or other characteristics. In some implementations, the motions, facial expressions, emotions, reactions, behaviors, and/or other characteristics can be derived from and/or mimic the motions, facial expressions, emotions, reactions, behaviors, and/or other characteristics of one or more real-world and virtual people or characters. The virtual characters depicted in the videos generated by the virtual character generation module 208A can also perform an action, initiate an interaction, and/or be responsive to one or more real-world and virtual people or characters. For example, the virtual characters can exhibit one or more motions, facial expressions, emotions, reactions, behaviors, and/or other characteristics that are indicative of an action being performed (e.g., head moving with a particular facial expression), an interaction being initiated (e.g., pursing lips and beginning to speak), and/or a reaction by the avatar (e.g., furrowing eyebrows).

The virtual character generation module 208A can be configured to store generated videos in the one or more storage devices 212, where they can be retrieved and/or accessed at a later time. In some implementations, the computing device 202 can be connected to a client device 224 via the network 222 and permit the client device 224 to retrieve and/or access generated videos. In some implementations, the computing device 202 can provide the generated videos to the client device 224 and/or to a cloud-based server system where they can be later accessed and/or retrieved by the computing device 202, the client device 224, and/or other devices. In some implementations, the computing device 202 and/or the client device 224 are configured to provide a graphical user interface page selecting generated videos for playback and presenting the selected generated videos on a display of the computing device 202 and/or the client device 224. In some implementations, the client device 224 can be configured to provide one or more interfaces, such as websites, portals, and/or software applications for presenting video depicting virtual characters. For example, a user of the client device 224 may access one or more of those interfaces using the one or more applications to view videos depicting virtual characters that are accessed and/or received from the computing device 202 and/or a cloud-based server system.

While the virtual character generation module 208A has been described as being configured to generate video depicting virtual characters, this is not intended to be limiting and the virtual character generation module 208A can be configured to generate animations, image sequences, image frames, and the like depicting virtual characters and other persons, subjects, and/or characters.

The one or more storage devices 212 can be configured to store information and data acquired, received, and/or generated by the computing device 202 (e.g., speaker videos, listener images, and videos depicting virtual characters such as those generated using the operations and methods, including parts thereof, described herein). The one or more storage devices 212 can be removable storage devices, non-removable storage devices, a combination thereof, and the like. Examples of removable storage and non-removable storage devices include solid-state drives (SSDs); magnetic disk devices such as flexible disk drives (FDDs) and hard disk drives (HDDs); optical disk drives such as compact disk (CD) drives and digital versatile disk (DVD) drives; tape drives; and the like.

The user interface 214 can include one or more devices that are configured to present images, videos (e.g., videos depicting virtual characters such as those generated using the operations and methods, including parts thereof, described herein), graphics, text, information, data, content, and the like and receive input. Examples of the devices that can be included in the user interface 214 include displays such as liquid crystal displays, light emitting diode displays, organic light emitting diode displays, touchscreen displays, and the like; audio transducers such as microphones, speakers, and the like; input/output components such as control members, control panels, switches, buttons, keyboards, mice, and the like.

The communication interface 216 can be configured to facilitate communications between the computing device 202 and the network 222 and other systems and devices. For example, the communication interface 216 can be configured to facilitate communications between the computing device 202 and a cloud-based server system (not shown), which can, in some implementations, perform some of the processing functions performed by processing system 204. In some implementations, using the communication interface 216, the cloud-based server system can be used to relay notifications to and/or store data generated by the computing device 202. In some implementations, to enable communications between the network 222 and/or a cloud-based server system, the communication interface 216 can include one or more communication devices such as wireless communication modules and chips, wired communication modules and chips, chips for communicating over local area networks, wide area networks, cellular networks, satellite networks, fiber optic networks, and the like, systems on chips, and other circuitry that enables the computing device 202 to send and receive data.

Although not shown, the computing device 202 can also include other components that can provide the computing device 202 with various functionality. Such other components can include power generating/storing devices, input/output (I/O) components, and the like. The foregoing configurations of the computing device 202 are not intended to be limiting and the computing device 202 can include other subsystems, devices, and components.

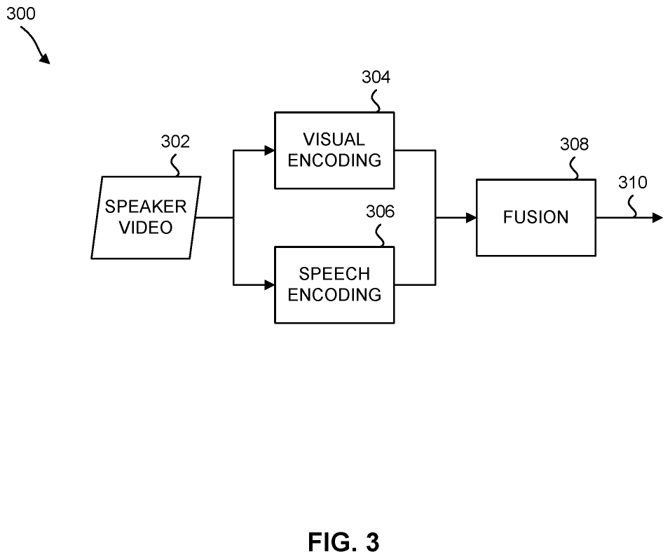

FIG. 3 illustrates an example of a feature extraction stage of a flow for generating videos depicting virtual characters. As shown in FIG. 3, the feature extraction stage 300 includes a visual encoding step 304, a speech encoding step 306, and fusion step 308. The feature extraction stage 300 is configured to access a speaker video 302 and process the speaker video 302 to generate style feature vectors 310. In some implementations, the speaker video 302 can be accessed from the computing device 202 and/or the speaker video providing entity 220. The speaker video 302 is then encoded at the visual encoding step 304 and speech encoding step 306.

The visual encoding step 304 is configured to analyze the speaker video 302, extract features from the speaker video 302, and generate feature vectors representing the visual features of the speaker video 302. The features extracted by the visual encoding step 304 can represent visual features of the speaker video 302 and the feature vectors can be multi-dimensional where the number of dimensions is defined in-part by the number of frames of the speaker video 302 and visual features being represented. In some implementations, the visual features can include facial expressions, head pose motion (e.g., rotation and translation), and blinks and the feature vector can include sequences of coefficients representing facial expressions, head pose motion, and blinks. For example, facial expressions made by the speaker during the speaker video 302 can be represented by the coefficient sequence βₛ(t), where β is selected from β∈ [symbol] ^{100T} and T is the length of the speaker video 302, head pose motion can be represented by the coefficient sequence pₛ(t), where p is selected from p∈ [symbol] ^{6T}, and blinks can be represented by the coefficient sequence ϕ(t), where ϕ is selected from ϕ∈ [symbol] ^{1T}. The visual encoding step 304 is configured to generate feature vectors from the speaker video 302 by generating, for each frame of the speaker video 302, a first vector representing a facial expression of the subject for the respective frame and a second vector representing motion of the subject for the respective frame and concatenating first and second vectors for the respective frame. The visual encoding step 304 is further configured to combine the concatenated first and second vectors for each frame of the speaker video 302 into the feature vectors. In some implementations, the visual encoding step 304 is configured to combine the concatenated first and second vectors by concatenating, adding, and/or averaging the concatenated first and second vectors for the frames of the speaker video 302.

In some implementations, the visual encoding step 304 can be configured to determine the sequences of coefficients using an optimization method such as Gause-Newtown Optimization, Bayesian Optimization, and the like. In some implementations, the visual encoding step 304 is configured to generate the feature vectors representing the speaker video 302 using one or more machine learning models (e.g., one or more neural networks). In some implementations, the one or more neural networks can include one or more convolutional layers and/or one or more activation layers such as rectified linear units (ReLus) and leaky rectified linear units (LeakyReLus). In some implementations, the one or more machine learning models are trained and fine-tuned with training data that includes videos labeled with ground-truth feature vectors representing visual features of the videos based on training and fine-tuning techniques such as unsupervised learning, semi-supervised learning, supervised learning, transfer learning, backpropagation, Adam optimization, reinforcement learning, and the like.

The speech encoding step 306 is configured to analyze an audio component of the speaker video 302 (e.g., the speech spoken by the subject of the speaker video 302), extract speech features from the audio component of the speaker video 302, and generate feature vectors representing audio features of the speaker video 302. The feature vectors generated by the speech encoding step 306 can represent the speech content of the speaker video 302 and the feature vectors can be multi-dimensional where the number of dimensions is defined in-part on the length of the speaker video 302 (e.g., the number of frames or samples). In some implementations, the feature vectors can include sequences of coefficients (e.g., α(t)) that represent an encoding of the extracted features. The speech encoding step 306 is configured to generate feature vectors from the speaker video 302 by generating, for each frame or sample of the audio component of the speaker video 302, a feature vector representing audio features of the respective frame or sample.

In some implementations, the features extracted can correspond to Mel-frequency cepstral coefficients or MFCC of the audio component of the speaker video 302 and can be encoded using one or more neural networks having one or more convolutional layers, LeakyReLu layers, and down sampling layers (e.g., ResNet-50 and Dropout). The one or more neural networks can be trained and fine-tuned with training data including videos labeled with ground-truth feature vectors representing audio or speech content of the videos. The one or more neural networks can be trained and fine-tuned using one or more training and fine-tuning techniques such as unsupervised learning, semi-supervised learning, supervised learning, transfer learning, backpropagation, Adam optimization, reinforcement learning, and the like.

The fusion step 308 is configured to calculate style feature vectors 310 (e.g., s_sty_{1:T}) that represent style-related features of the speaker video 302 (e.g., represents the fluctuation of the speaker's movements relative to time and/or the speaker's movement style). In some implementations, a style feature vector is included in the style feature vectors 310 for each frame of the speaker video 302. In some implementations, a style feature vector is included in the style feature vectors 310 for one or more frames of the speaker video 302. In some implementations, the style feature vectors 310 collectively are a continuous-value space that represents the cross-modal information derived from the speaker of the speaker video 302 that should be represented by the virtual character such that the virtual character can be responsive to the speaker (e.g., emotional value, utterance semantics, and response guidance). The style feature vectors 310 can be multi-dimensional where the number of dimensions is defined in-part on the length of the speaker video 302 (e.g., the number of frames or samples). The fusion step 308 is configured to calculate the style feature vectors 310 by combining respective feature vectors generated by the visual encoding step 304 with respective feature vectors generated by the speech encoding step 306. In some implementations, a style feature vector for each frame or sample of the speaker video 302 can be calculated as shown in Equation 1.

$${s}_{sty} ( t ) = α ( t ) ⊕ σ ( β ( t ) ) ⊕ σ ( \frac{\partial β ( t )}{\partial t} ) ⊕ σ ( \frac{\partial p ( t )}{\partial t} ) . \qquad [ 1 ]$$

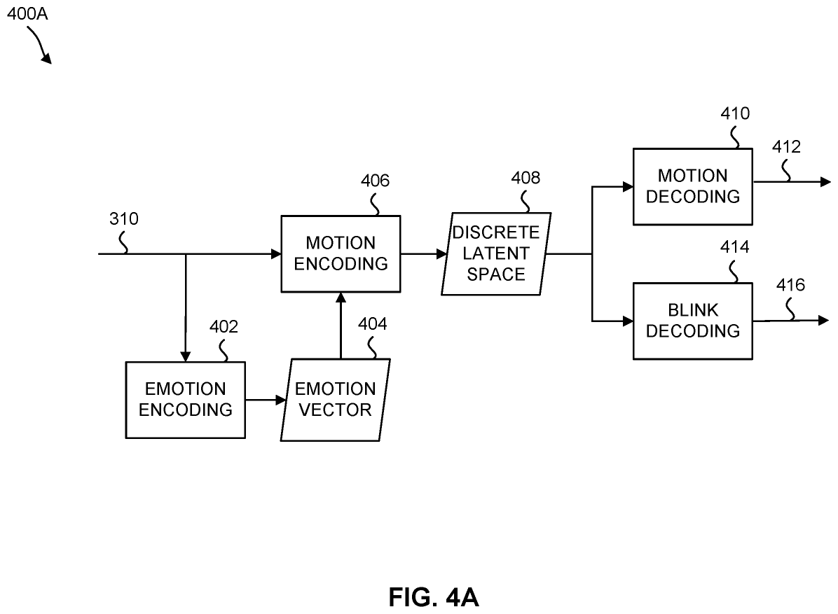

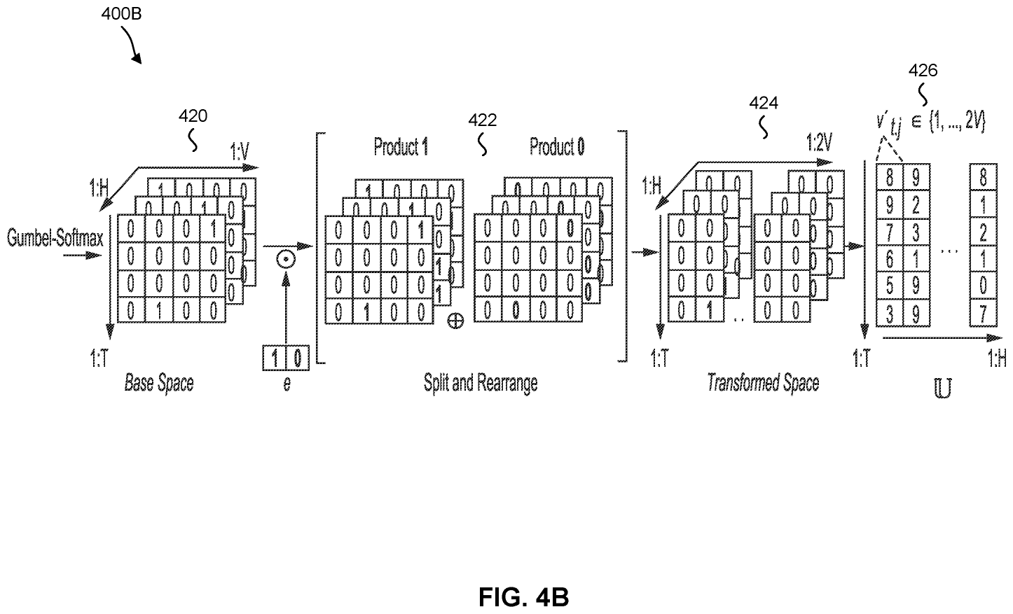

FIG. 4A illustrates an example of an adaptive space encoding stage of the flow for generating videos depicting virtual characters. As shown in FIG. 4A, the adaptive space encoding stage 400 includes an emotion encoding step 402, a motion encoding step 406, a motion decoding step 410, and a blink decoding step 414. The adaptive space encoding stage 400 processes the style feature vectors 310 to generate sets of emotion-coupled motion coefficients 412 and a sequence of blink coefficients 416.

The emotion encoding step 402 is configured to generate emotion vectors 404 from the style feature vectors 310. The emotion vectors 404 can represent one or more emotional characteristics of the speaker (i.e., subject) of the speaker video 302. In some implementations, the one or more emotional characteristics can represent positive, neutral, and/or negative emotions or emotional states present within or that can be invoked by the video and audio components of the speaker video 302. In some implementations, the emotion vectors 404 includes a series of one-hot vectors corresponding to the style feature vectors 310. For example, the emotion vectors 404 can include a one-hot vector for each style feature vector included in the style feature vectors 310. In some implementations, a positive emotion of the subject of the speaker video 302 can be represented as the one-hot vector [1, 0, 0], a neutral emotion of the subject of the speaker video 302 can be represented as the one-hot vector [0, 1, 0], and a negative emotion of the subject of the speaker video 302 can be represented as the one-hot vector [0, 0, 1]. As such, by including a series of one-hot vectors, the emotion vector 404 for the speaker video 302 can represent any positive, neutral, and/or negative emotions or emotional states exhibited or represented by the subject of the speaker video 302.

In some implementations, the emotion encoding step 402 can generate the emotion vectors 404 from the style feature vectors 310 using one or more neural networks (e.g., one or more time-delay neural networks or TDNNs and multi-layer perceptron), which can divide the style feature vectors 310 or speaker video 302 into segments (e.g., time intervals) using a sliding window operation such that each window represents one or more frames of the speaker video 302 (e.g., at least one style feature vector) and encode the segments into the generated emotion vectors 404. For example, for a speaker video having a length T and a framerate of 25 frames per second and style feature vectors 310 each having a dimension D, the TDNN can encode a series of the style feature vectors 310 (s_sty_{1:T}∈ [symbol] ^{25T×D}) into the emotion vectors 404, where [symbol] is a set of real numbers based on the length of the speaker video 302.

In some implementations, to generate the emotion vectors 404, the one or more neural networks can be trained and fine-tuned with training data including audio samples including speech content with ground-truth feature vectors representing emotional characteristics of the speech content. In some implementations, a process for training and fine-tuning the one or more neural networks can be based on a speech emotional disentanglement technique that encodes semantic and emotion information the audio samples, combines the encoded information, and decodes the combined information into reconstructed audio signals. The reconstructed audio signals can then be compared to the audio samples to determine a loss (i.e., the difference between the audio samples and the audio signals), which can then be minimized over a number of training iterations. During the training process, candidate parameters can be identified until the loss is minimized. The candidate parameters resulting the loss being minimized can be set as the parameters for the one or more neural networks.

The motion encoding step 406 is configured to generate discrete latent spaces 408 from the style feature vectors 310 and the emotion vectors 404. The discrete latent spaces 408 represent one or more motion characteristics of the speaker of the speaker video 302 as a probability distribution which can then be used to predict motion/motions of the virtual character (to be described later). To generate the discrete latent spaces 408, for each discrete latent space to be generated, a base space that includes one-hot vectors is calculated from the style feature vectors 310 and the base space processed into a discrete latent space of the discrete latent space 408. The base space can be a three-dimensional T×H×V-dimensional latent space in continuous space, where T represents length of the speaker video 302 in frames, H is the number of latent classification heads, and V is the number of categories. The base space can be calculated from the style feature vectors 310 using a Gumbel-SoftMax function, as shown in Equation 2:

$${v}_{t ; h ; 1} = {[ Gumbel - SoftMax ( enc {( {s}_{s t y} )}_{t , h , 1 : V} ]}_{1 : H ; {1}^{′}} \qquad [ 2 ]$$

where v_{t;h;1} represents each codeword value of the base space, and where enc(s_sty)_{t,h,1:V} represents the encoded style feature vectors 310.

The base space can be processed into a transformed space by taking a dot product of the base space and each coefficient of the emotion vectors 404 to generate sub-base spaces, concatenating the sub-base spaces to generate an intermediate base space, and expanding the dimensions of the intermediate base space to generate the transformed space by multiplying the V dimension of the intermediate base space by the number of emotion categories (e.g., N emotion categories) in represented by the emotion vectors 404. In some implementations, the transformed space is a three-dimensional T×H×NV-dimensional latent space in continuous space. The discrete latent space can be calculated by computing the argument maximum on the transformed space where codeword values of the discrete latent space can be in the range of {v′_{1:T,1:H}|v′_{i,j}∈[1, 2, . . . , NV]}. An example of a flow for processing the base space into the discrete latent space is shown in FIG. 4B. As shown in FIG. 4B, the base space 420 can be processed into sub-base spaces 422 that are further processed (e.g., by concatenating the sub-base spaces to generate an intermediate base space and expanding the dimensions of the intermediate base space) to generate the transformed space 424, which is processed into the discrete latent space (e.g., by computing the argument maximum on the transformed space).

The motion decoding step 410 is configured to generate sets of emotion-coupled motion coefficients 412 (e.g., β_{pred}(t), p_{pred}(t)) from the discrete latent spaces 408. The sets of emotion-coupled motion coefficients 412 can represent learned emotional facial expressions and emotional head pose motions performed by the speaker of the speaker video 302. The blink decoding step 414 is configured to generate a sequence of blink coefficients 416 (e.g., ϕ_{pred}(t)) from the discrete latent spaces 408. The sequence of blink coefficients 416 can represent the learned blink sequence performed by the speaker over the duration t (e.g., frames) of the speaker video 302. In some implementations, a blink coefficient of the sequence of blink coefficients 416 can be a 1 or 0, with 1 representing that a blink is performed by the speaker over the duration t (e.g., a blink performed by the speaker in a frame of the speaker video 302) and 0 representing that no blink is performed by the speaker over the duration t (e.g., the speaker's eyes are open in a frame of the speaker video 302). As such, the sequence of blink coefficients 416 can include a sequence of 1's and 0's representing frames of the speaker video 302 in which the speaker blinks. The motion decoding step 410 and blink decoding step 414 can be configured to generate the sets of emotion-coupled motion coefficients 324 and sequence of blink coefficients 416 using one or more neural networks. In some implementations, the one or more neural networks can include one or more activation layers and/or one or more long short-term memory (LSTM) layers.

The adaptive space encoding stage 400A can be implemented using one or more machine learning models (e.g., one or more transformer-based models). In some implementations, the one or more machine learning models can be trained and fine-tuned with training data including videos labeled with ground-truth feature vectors representing motion content, audio or speech content, emotional content of the videos. The one or more neural networks can be trained and fine-tuned using one or more training and fine-tuning techniques such as unsupervised learning, semi-supervised learning, supervised learning, transfer learning, backpropagation, Adam optimization, reinforcement learning, and the like.

To train the one or more machine learning models, a parameter series β′(t), p′(t) can be reconstructed from previously generated videos that have been adopted as ground truths and a set of style feature vectors s_sty(t) can be calculated for the videos. The s_sty(t) can be used by the one or more machine learning models to predict parameters β_{pred}(t), p_{pred}(t) and a blink sequence ϕ_{pred}(t) for a to-be-generated video. Based on the predicted parameters, an L2 loss as shown in Equation 3 can be applied:

$${ℒ}_{{L}_{2}} = {\sum }_{t = 1}^{T} {‖ {β}_{pred} ( t ) - {β}^{′} ( t ) ‖}_{2} + {‖ {p}_{prep} ( t ) - {p}^{′} ( t ) ‖}_{2} . \qquad [ 3 ]$$

The blink sequence can be taken as a decision at each time instance t, and a cross-entropy loss for binary classification can be used, where the ϕ(t) is the ground truth blink state as shown in Equation 4:

$${ℒ}_{C {E}_{1}} = - {\sum }_{t = 1}^{T} ∅ ( t ) log {∅}_{pred} ( t ) + [ 1 - ∅ ( t ) ] log 1 - {∅}_{pred} ( t ) ] . \qquad [ 4 ]$$

In some implementations, a regularization loss as shown in Equation 5 can be used to suppress noises and encourage a more concentrated density distribution (e.g., a blinking sequence with the same consecutive blink motion) comprises several consecutive 1 values):

$${ℒ}_{reg} = {\sum }_{t = 2}^{T} {‖ {∅}_{pred} ( t ) - {∅}_{pred} ( t - 1 ) ‖}_{1} . \qquad [ 5 ]$$

Additionally, in some implementations, at the emotion encoding step 402, a cross entropy loss can be applied to the TDNN based on a ground truth one-hot emotion vector e, as is shown in Equation 6:

$${ℒ}_{C {E}_{2}} = - {\sum }_{i = 1}^{N} {e}_{i} log {e}_{i}^{′} + [ 1 + {e}_{i} ] log [ 1 - {e}_{i}^{′} ] . \qquad [ 6 ]$$

The final loss can then be defined as is shown in Equation 7:

$$ ℒ = {ℒ}_{{L}_{2}} + {λ}_{1} {ℒ}_{C {E}_{1}} + {λ}_{2} {ℒ}_{C {E}_{2}} + {λ}_{3} {ℒ}_{reg} , \qquad [ 7 ]$$

where the λ₁, λ₂, and λ₃ are three weight to balance these terms.

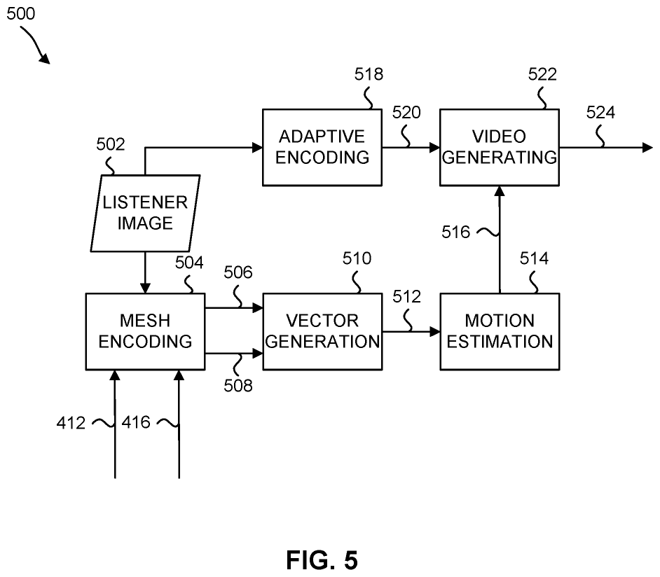

FIG. 5 illustrates an example of a rendering stage of the flow for generating videos depicting virtual characters. As shown in FIG. 5, the rendering stage 500 includes a mesh encoding step 504, a vector generation step 510, a motion estimation step 514, an adaptive encoding step 518, and a video generating step 522. The rendering stage 500 begins with accessing a listener image 502 and the speaker video 302 and processing the listener image 502, the speaker video 302, the sets of emotion-coupled motion coefficients 412, and the sequence of blink coefficients 416 to generate a video 524 depicting a virtual character. In some implementations, the listener image 502 can be accessed from the computing device 202 and/or the listener image providing entity 218.

The mesh encoding step 504 is configured to generate an image mesh 506 and generate a video mesh 524. To generate the image mesh 506, the mesh encoding step 504 is configured to analyze the listener image 502, extract features from the listener image 502, and generate a mesh that represents the features of the listener image 502. The features extracted by the visual encoding step 304 can represent visual and geometrical features of the listener image 502 and the image mesh 506 can be multi-dimensional where the number of dimensions is defined in-part by the number of visual and geometrical features being represented. In some implementations, the visual and geometrical features can include facial expression, a geometry, and a scale of the person, subject, or character depicted by the listener image 502. In some implementations, to generate the image mesh 506 and the video mesh 524, the mesh encoding step 504 is configured to use one or more image processing algorithms to segment the listener image 502 and one or more image processing algorithms to map the segmented elements to mesh elements of the image mesh 506.

To generate the video mesh 524, the mesh encoding step 504 is configured to apply the sets of emotion-coupled motion coefficients 412 to the image mesh 506 to generate a sequence of video mesh frames collectively forming the video mesh 524. In some implementations, the mesh encoding step 504 is configured to use a set of emotion-coupled motion coefficients of the sets of emotion-coupled motion coefficients 412 to transform the image mesh 506 into a video mesh frame and, by using each set of emotion-coupled coefficients of the sets of emotion-coupled coefficients, the image mesh 506 can be transformed into the sequence of video mesh frames. In some implementations, the video mesh 524 represents the face expression, geometry, and scale of the person, subject, or character depicted by the listener image 502 expressing and moving as represented by the facial expressions and head movement (e.g., rotation and translation) features of the speaker of the speaker video 302.

To control the blinking of the virtual character, the mesh encoding step 504 can be configured to analyze the sequence of blink coefficients 416 to determine groups of blink frames in which the speaker of the speaker video 302 is blinking and groups of no-blink frames in which the speaker of the speaker video 302 is not blinking. The emotion-coupled motion coefficients of the sets of emotion-coupled motion coefficients 412 at the start frame and end frame of each group of blink frames are identified and then interpolated over half the length of time between the start frame and end frame of a respective group of blink frames to determine an interpolated emotion-coupled motion coefficients between the start frame and end frame of the respective group of blink frames. The interpolated emotion-coupled motion coefficients can represent a blink state of the speaker over the duration from the start frame to the end frame of the respective group. In generating the video mesh 524, the interpolated emotion-coupled motion coefficients can be linearly weighted, which can simulate an eyelid position of the virtual character at each timestamp for physical blink and/or emotional events around the eyes of the virtual character.

The vector generation step 510 is configured to generate a set of sparse motion vectors 512. The vector generation step 510 is configured to generate the set of sparse motion vectors 512 by calculating differences in positions between keypoints of respective video mesh frames of the video mesh 524 and corresponding keypoints of the image mesh 506. For example, a difference between keypoints positions in a respective video mesh frame of the video mesh 524 and corresponding keypoint positions in the image mesh 506 can be calculated to determine a movement amount and a movement direction of the keypoints in the respective video mesh frame with respect to the corresponding keypoints in the image mesh 506. The vector generation step 510 can be configured to calculate keypoints using one or more keypoint detection algorithms. In some implementations, at least one keypoint detection algorithm can be based on a U-Net architecture. In some implementations, the vector generation step 510 can be configured to generate the set of sparse motion vectors 512 from the keypoints using a Jacobian matrix through deformation.

The motion estimation step 516 is configured to predict a set of occlusion maps 516. The set of occlusion maps 516 identify regions in a generated video frames (to be described later) in which the content of those regions can be generated by warping portions of the listener image 502 and those regions in which the content of those regions can be generated by inpainting. To predict the set of occlusion maps 516, the motion estimation step 516 is configured to first compute a dense motion field. The dense motion field facilitates aligning features encoded from the listener image 502 (to be described later) to the facial pose of the speaker of the speaker video 302. In some implementations, the features can be aligned using a mapping function that correlates corresponding pixels in the listener image 502 and frames of the speaker video 302. In some implementations, the dense motion field is computed using a convolutional neural network. Once the dense motion field is computed, for each keypoint, a heatmap is generated from the dense motion field where each heatmap localizes one or more regions where the transformations are most relevant. The set of occlusion maps 516 can be predicted from the heatmaps by concatenating the heatmaps with the set of sparse motion vectors 512.

The adaptive encoding step 518 is configured to extract high-frequency features 520 from the listener image 502. To extract the high-frequency features 520, the adaptive encoding step 518 is configured to learn facial transformation features and texture features from the listener image 502. In some implementations, the adaptive encoding step 518 can employ one or more machine learning models (e.g., one or more neural networks), which can be trained and fine-tuned with training data that includes pairs of high-quality images and low-quality images. The one or more machine learning models can be trained and fine-tuned using one or more training and fine-tuning techniques such as unsupervised learning, semi-supervised learning, supervised learning, transfer learning, backpropagation, Adam optimization, reinforcement learning, and the like.

To train and/or fine-tune the one or more machine learning models, a set of first source images having a first quality level (e.g., a high-quality level) can be obtained and/or accessed. Each first source image of the set of first source images can be degraded to result in a set of second source images having a second quality (e.g., a low-quality level, where the low-quality level indicates that a respective image has a lower quality than a respective image of the set of first source images). The first source images can be degraded by adding noise, resizing the image (e.g., area, bilinear, bicubic), and compressing the image. The set of first source images and the set of second source images can be paired such each first source image is paired with a respect second source image. The training data can include pairs of first and second source images and, during training, the one or more machine learning models can learn to extract high-frequency features from source images. In some implementations, rather than degrading the first source images, super resolution processing can be applied to enhance the first source images. As such, training pairs can be formed with the first source images and the enhanced first source images. In some implementations, training examples can include a first source image, an enhanced source image, and a second source image. In this way, the one or more machine learning models can map features between images having varying levels of quality.

The video generating step 522 is configured to generate the video 524 depicting a virtual character using the set of occlusion maps 516 and the high-frequency features 520. In some implementations, to generate the video 524, the video generating step 522 is configured to generate a video frame of the video 524 from an occlusion map of the set of occlusion maps 516 and the high-frequency features 520 and combined the generated video frames into the video 524. To generate the video frames, the video generating step 522 is configured to learn a mapping function that can convert an occlusion map of the set of occlusion maps 516 and the high-frequency features 520 into a video frame. In some implementations, to learn the mapping function, the video generating step 522 can employ one or more machine learning models (e.g., one or more deep convolutional networks), which can be trained and fine-tuned with training data that includes videos labeled with ground-truth occlusion maps and high-frequency features. The one or more machine learning models can be trained and fine-tuned using one or more training and fine-tuning techniques such as unsupervised learning, semi-supervised learning, supervised learning, transfer learning, backpropagation, Adam optimization, reinforcement learning, and the like.

To improve video generation, the rendering stage 500 and/or video generating step 506 can employ a plurality of loss functions that can be divided into two categories with one category focusing on facial reconstruction and guiding the facial movement in sparse motion fields and the other category focusing on image quality. Examples of losses include facial structure losses, equivariance and deformation loss, perceptual loss, and GAN loss. The facial structure losses aim to ensure that both the expressions and poses in the synthesized facial images closely match those in the ground-truth images. These losses include various components, including keypoints loss, head pose loss, and facial expression loss. The keypoints loss refers to the L2 distance performed on the keypoints with corresponding depth information (i.e., spatial dimension), while both the head pose loss and facial expression loss utilize L1 distance over the estimated facial parameters. The equivariance loss ensures consistency of image-specific keypoints in 2D to 3D transformations and the deformation loss constrains the canonical space to the camera space transformation. The perceptual loss is calculated from the feature maps front activation layers of the model and the GAN loss is multi-resolution patch loss, where the discriminator predicts at the multiple patch-levels and a feature matching loss is used to optimize the discriminators.

The virtual character depicted by the video 524 can appear to be listening to the speaker of the speaker video 302. In some implementations, the speaker of the speaker video 302 can be speaking on a topic that is emotional and/or can invoke an emotion in a listener and the virtual character can appear to exhibit one or more emotions (e.g., by exhibiting motions, facial expressions, and/or eye blinks representative of one or more emotions) as if they are listening to speaker. In other words, the video can depict the person or character of the listener image 502 exhibiting an emotional reaction, including eye blinks, that is responsive to the person or character speaking and/or the speech spoken by the person or character speaking of the speaker video 302.

Additionally, or alternatively, the virtual character depicted in the video 524 can exhibit lifelike motions, facial expressions, emotions, reactions, behaviors, and/or other characteristics. In some implementations, the motions, facial expressions, emotions, reactions, behaviors, and/or other characteristics can be derived from and/or mimic the motions, facial expressions, emotions, reactions, behaviors, and/or other characteristics of one or more real-world and virtual people or characters. The virtual character depicted by the video 524 can also perform an action, initiate an interaction, and/or be responsive to one or more real-world and virtual people or characters. For example, the virtual character can exhibit one or more motions, facial expressions, emotions, reactions, behaviors, and/or other characteristics that are indicative of an action being performed (e.g., head moving with a particular facial expression), an interaction being initiated (e.g., pursing lips and beginning to speak), and/or a reaction by the avatar (e.g., furrowing eyebrows).

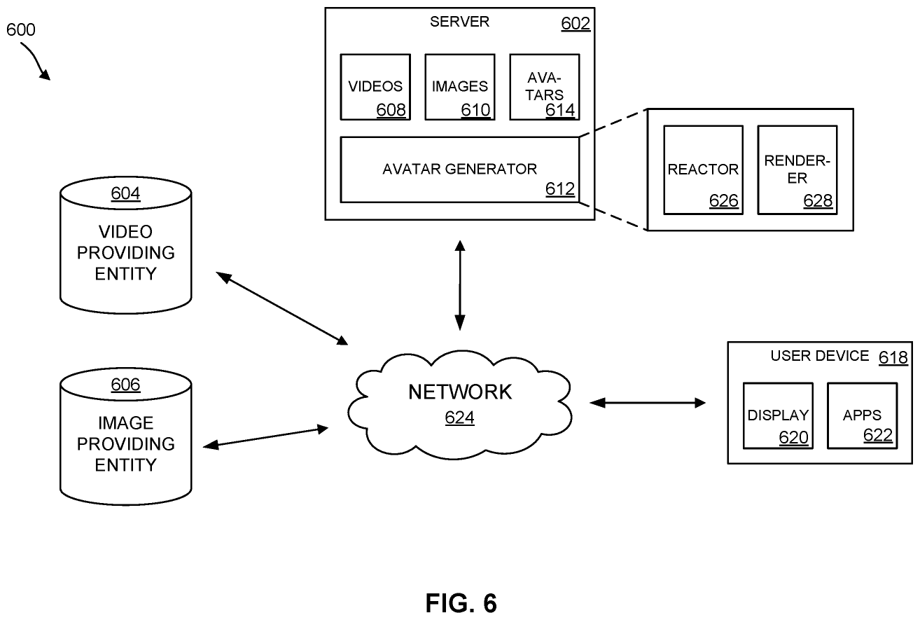

FIG. 6 illustrates an example of an avatar generation system. In some implementations, as shown in FIG. 6, the system 600 includes a server 602, a video providing entity 604, an image providing entity 606, and a user device 618. The server 602, video providing entity 604, image providing entity 606, and user device 618 can be in communication with each other via a network 624. The network 624 can be any kind of wired or wireless network that can facilitate communications among components of the system 600. For example, the network 624 can facilitate communication between and among the server 602, video providing entity 604, image providing entity 606, and user device 618. The network 624 can include one or more public networks, one or more private networks, and any combination thereof. Additionally, the network 624 can be a local area network, a wide area network, the Internet, a Wi-Fi network, a Bluetooth® network, and the like.

The server 602 can be a server that facilitates human-computer interaction as described above. The server 602 is configured with hardware and software that enables the server 602 to store and manage data and generate avatars in accordance with a part of or all the techniques described herein. The server 602 can be implemented as a computing device such as the computing device 202 shown in FIG. 2. In some examples, the server 602 can be a desktop computer, a personal computer, a workstation and/or any variation thereof. In other examples, the server 602 can form part of a distributed computing system such as a cloud computing system. In further examples, the server 602 may be any kind of electronic device that is configured to store and manage data and generate avatars in accordance with a part of or all the techniques described herein.

The server 602 can include one or more special-purpose or general-purpose processors. Such special-purpose processors may include processors that are specifically designed to perform the functions of the components such as the avatar generator 612 described herein. Such special-purpose processors may be application-specific integrated circuits ASICs, field-programmable gate arrays FPGAs, programmable logic devices (PLDs) which are general-purpose components that are physically and electrically configured to perform the techniques described herein. Such general-purpose processors may execute special-purpose software that is stored using one or more non-transitory processor-readable mediums, such RAM, flash memory, a HDD, or a SSD. Further, the functions of the components of the server 602 can be implemented using a cloud-computing platform, which is operated by a separate cloud-service provider that executes code and provides storage for clients.

In some implementations, the server 602 includes a video data store 608, an image data store 610, an avatar generator 612, and an avatar data store 614. The video data store 608 can be configured to store videos received from a video provider or providing entity such as the video providing entity 604. Each of the videos can depict a subject that is speaking and include an audio component representing the subject's speech. For example, a video received from the video providing entity 604 can be a video of a person speaking and the audio component of the video can be the person's speech. The subject can have an emotional state. For example, the subject can have a positive emotional state, neutral emotional state, or negative emotional state. The image data store 610 can be configured to store images received from an image provider or providing entity such as the image providing entity 606. Each of the images can depict a portrait image of a subject. For example, an image received from the image providing entity 606 can be a portrait image of a subject. The subject of the image can be a different subject from or the same subject as the subject depicted by the video.

The avatar generator 612 can be configured to generate avatars based on a video stored in the video data store 608 and an image stored in the image data store 610. An avatar generated by the avatar generator 612 can be a video, animation, sequence of images, and the like. The avatar can represent one or more virtual or real-world users (e.g., a person, character, player, object, and/or any combination thereof). In some implementations, the avatar can represent a head and/or a body of a virtual and/or real-world user.

The avatar can exhibit lifelike motions, expressions, emotions, behaviors, and/or other characteristics. In some implementations, the motions, expressions, emotions, behaviors, and/or other characteristics can be derived from and/or mimic the motions, expressions, emotions, behaviors, and/or other characteristics of one or more other virtual and/or real-world users. The avatar can also perform an action, initiate an interaction, and/or be responsive to other virtual and/or real-world users. For example, the avatar can exhibit one or more motions, expressions, emotions, behaviors, and/or other characteristics that are indicative of an action being performed (e.g., head moving with a particular facial expression), an interaction being initiated (e.g., pursing lips and beginning to speak), and/or a reaction by the avatar (e.g., furrowing eyebrows). In another example, the avatar can be a talking avatar that initiates a conversation with or speaks to another virtual and/or real-world user and/or the avatar can be a listening avatar that responds to or listens to another virtual and/or real-world user.

The avatar can also exhibit emotional reactions and eye blinks in response to interactions with other virtual and/or real-world users. For example, a virtual and/or real-world user can be speaking on a topic that is positive and an avatar generated by the avatar generator 612 can exhibit happiness (e.g., smiling facial expressions). In another example, a virtual and/or real-world user can be speaking on a topic that is neutral and an avatar generated by the avatar generator 612 can exhibit neutrality (e.g., muted facial expressions). In a further example, a virtual and/or real-world user can be speaking on a topic that is negative and an avatar generated by the avatar generator 612 can exhibit unhappiness (e.g., frowning facial expressions). The avatar implementations described above are not intended to be limiting and other avatar implementations are possible.

The avatar data store 614 can be configured to store avatars generated by the avatar generator 612. In some implementations, the server 602 can be configured to allow an entity or device such as user device 618 to access the avatars stored in the avatar data store 614. In some implementations, the server 602 can be configured to provide a graphical user interface that includes one or more avatars selected from the avatar data store 614 to the user device 618. For example, the server 602 can select one or more avatars from the avatar data store 614 can transmit program code (e.g., HTML, CSS, or JS) defining the graphical user interface to the user device 618. The program code can be executable or interpretable by the user device 618 to generate the graphical user interface for display on a display 620 of the user device 618. The user device 618 can present the graphical user interface to the user in any suitable manner, such as through one or more applications 622. The one or more applications 622 can be installed on the user device 618. In some implementations, the one or more applications 622 are cloud-based and provided to the user device 618 via one or more communication channels. In some implementations, the user device 618 can be configured to provide one or more interfaces, such as websites, portals, and/or software applications for presenting and interacting with avatars. A user of user device 618 may access one or more of those interfaces using the one or more applications 622 to view the graphical user interface and other interfaces and view and interact with avatars.

The user device 618 can be implemented in various configurations to provide various functionality to a user. For example, the user device 618 can be implemented as the computing device 202 shown in FIG. 2. In other examples, the user device 618 can be implemented as an assistant device, a smart home controller or device, a gaming device (e.g., a gaming system, gaming controller, data glove, etc.), a communication device (e.g., a smart phone, cellular phone, mobile phone, wireless phone, portable phone, radio telephone, etc.); and/or other computing device (e.g., a tablet computer, phablet computer, notebook computer, laptop computer, etc.). The foregoing implementations are not intended to be limiting and the user device 618 can be implemented as any kind of electronic or computing device that can be configured to provide access to one or more graphical user interfaces and interfaces for enabling users to view and interact with avatars generated using a part of or all the techniques disclosed herein.

As shown in FIG. 6, the avatar generator 612 can include a reactor 626 and a renderer 628. The reactor 626 is configured to receive a video stored in the video data store 608 and an image stored in the image data store 610 and generate coefficients. As discussed above, the video can depict a subject that is speaking and include an audio component representing the subject's speech. The subject can have an emotional state. For example, the subject can have a positive emotional state, neutral emotional state, or negative emotional state. The image can depict a portrait image of a subject that is a different subject from or the same subject as the subject depicted by the video. In some implementations, the renderer 628 is configured to receive the image and/or the coefficients and generate an avatar exhibiting one or more emotional reactions and eye blinks in response to the emotional state of the subject depicted by the video. For example, as discussed above, the subject of the video can be speaking on a topic that is negative and an avatar generated by the renderer 628 can exhibit unhappiness (e.g., frowning facial expressions and periodic eye blinks) in response to the emotional state of the subject of the video.

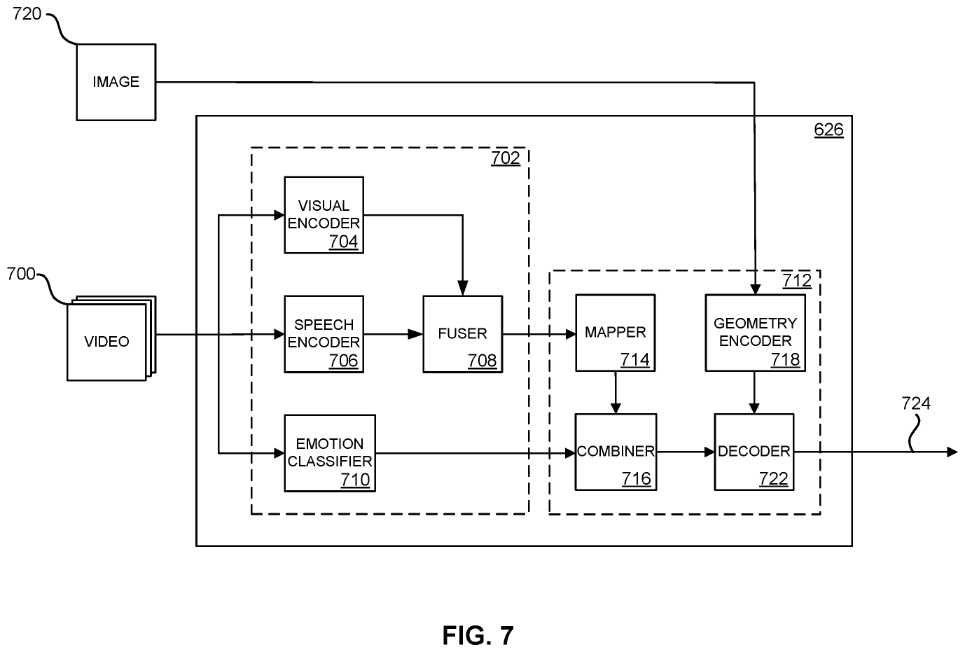

FIG. 7 is a simplified block diagram of a reactor such as reactor 626 of the avatar generator 612. The reactor 626 includes an encoder component 702 and a decoder component 712. The encoder component 702 is configured to receive the video 700 as an input, generate feature vectors from the video 700, and generate a continuous latent space from the feature vectors. The decoder component 712 is configured to receive the image 720 and the continuous latent space, generate a discrete latent space from the continuous latent space, combine the discrete latent space with an emotional characteristic of the subject of the video, and decode the combined discrete latent space and emotional characteristic into the coefficients 724.

The encoder component 702 includes a visual encoder 704 configured to generate a feature vector from the video 700. The feature vector generated by the visual encoder 704 can represent visual features of the video 700. The feature vector can be multi-dimensional where the number of dimensions is defined the number of frames of the video 700. In some implementations, the visual features can represent a facial expression of the subject of the video 700 and a motion (e.g., rotation and translation) of the subject of the video 700. The visual encoder 704 is configured to generate a feature vector from the video 700 by generating, for each frame of the video 700, a first vector representing a facial expression of the subject for the respective frame and a second vector representing motion of the subject for the respective frame and concatenating first and second vectors for the respective frame. The visual encoder 704 is further configured to combine the concatenated first and second vectors for the frames of the video 700 into the feature vector. In some implementations, the visual encoder 704 is configured to combine the concatenated first and second vectors by concatenating, adding, and/or averaging the concatenated first and second vectors for the frames of the video 700.

In some implementations, the visual encoder 704 is configured to generate feature vectors using one or more neural networks (e.g., convolutional neural networks and/or recurrent neural networks) trained and fine-tuned with training data including videos labeled with ground-truth feature vectors representing visual features of the videos. In some implementations, the one or more neural networks can include one or more activation layers such as rectified linear units (ReLus) and leaky rectified linear units (LeakyReLus). The one or more neural networks can be trained and fine-tuned using one or more loss functions and one or more training and fine-tuning techniques such as unsupervised learning, semi-supervised learning, supervised learning, transfer learning, backpropagation, Adam optimization, reinforcement learning, and the like. The foregoing implementations are not intended to be limiting and other visual encoding arrangements are possible.

During training and fine-tuning of the visual encoder 704, a set of parameters (e.g., weights and/or biases) can be determined for the visual encoder 704. To determine the set of parameters, videos of training data can be encoded by the visual encoder 704 and compared to ground-truth information (e.g., ground-truth facial expression information and ground-truth motion information) included in the training data using a loss function. For example, the loss function can include an expression loss that represents the distance between an encoded facial expression and ground-truth facial expression information and a motion loss that represents the distance between encoded motion and ground-truth motion information. In some implementations, hyperparameters can be selected and the loss can be calculated based on the selected hyperparameters. The set of parameters can be determined by maximizing or minimizing the loss. The hyperparameters can be selected to control the behavior of the visual encoder 704. For example, if the loss is not maximized or minimized, the hyperparameters can be adjusted and loss can be calculated based on the adjusted hyperparameters. As part of the training, techniques such as Adam optimization, backpropagation, random feedback, Direct Feedback Alignment (DFA), Indirect Feedback Alignment (IFA), Hebbian learning, and the like can be used to determine the set of parameters to minimize or maximize the loss function.

The encoder component 702 also includes a speech encoder 706 configured to generate a feature vector from the video 700. The feature vector generated by the speech encoder 706 can represent audio (e.g., speech) content of the video 700. The feature vector can be multi-dimensional where the number of dimensions is defined the length of the video 700 (e.g., the number of frames).

In some implementations, the speech encoder 706 is configured to generate feature vectors using one or more neural networks trained and fine-tuned with training data including videos labeled with ground-truth feature vectors representing audio or speech content of the videos. In some implementations, the one or more neural networks can include one or more convolutional layers, LeakyReLu layers, and down sampling layers. The one or more neural networks can be trained and fine-tuned using one or more loss functions and one or more training and fine-tuning techniques such as unsupervised learning, semi-supervised learning, supervised learning, transfer learning, backpropagation, Adam optimization, reinforcement learning, and the like. The foregoing implementations are not intended to be limiting and other audio encoding arrangements are possible.

During training and fine-tuning of the speech encoder 706, a set of parameters can be determined for the speech encoder 706. To determine the set of parameters, videos of training data can be encoded by the speech encoder 706 and compared to ground-truth information (e.g., ground-truth speech content) included in the training data using a loss function. For example, the loss function can include a speech content loss that represents the distance between encoded speech content and ground-truth speech content. In some implementations, hyperparameters can be selected and the loss can be calculated based on the selected hyperparameters. The set of parameters can be determined by maximizing or minimizing the loss. The hyperparameters can be selected to control the behavior of the speech encoder 706. For example, if the loss is not maximized or minimized, the hyperparameters can be adjusted and loss can be calculated based on the adjusted hyperparameters. As part of the training, techniques such as Adam optimization, backpropagation, random feedback, Direct Feedback Alignment (DFA), Indirect Feedback Alignment (IFA), Hebbian learning, and the like can be used to determine the set of parameters to minimize or maximize the loss function.

The encoder component 702 also includes a fuser 708 configured to generate a continuous latent space for the video 700. The fuser 708 is configured to generate a continuous latent space for the video 700 combining the feature vector generated by the visual encoder 704 with the feature vector generated by the speech encoder 706 and encoding the combined feature vectors. In some implementations, the fuser 708 is configured to combine the feature vectors by concatenating, adding, and/or averaging the feature vectors.

In some implementations, the fuser 708 is configured to generate continuous latent spaces using one or more neural networks trained and fine-tuned with training data including videos labeled with ground-truth feature vectors representing video and audio features of the videos and latent spaces for the videos. In some implementations, the one or more neural networks can include one or more activation layers. The one or more neural networks can be trained and fine-tuned using one or more loss functions and one or more training and fine-tuning techniques such as unsupervised learning, semi-supervised learning, supervised learning, transfer learning, backpropagation, Adam optimization, reinforcement learning, and the like. The foregoing implementations are not intended to be limiting and other fusion arrangements are possible.

The encoder component 702 also includes an emotion classifier 710 configured to generate a feature vector from the video 700. The feature vector generated by the emotion classifier 710 can represent an emotional characteristic of the subject of the video 700. In some implementations, the emotional characteristic can represent a positive emotion, neutral emotion, and/or negative emotion of the subject of the video 700. For example, the feature vector generated by the emotion classifier 710 can be a one-hot vector in which a positive emotion of the subject of the video 700 is represented as [1, 0, 0], a neutral emotion of the subject of the video 700 is represented as [0, 1, 0], and a negative emotion of the subject of the video 700 is represented as [0, 0, 1].

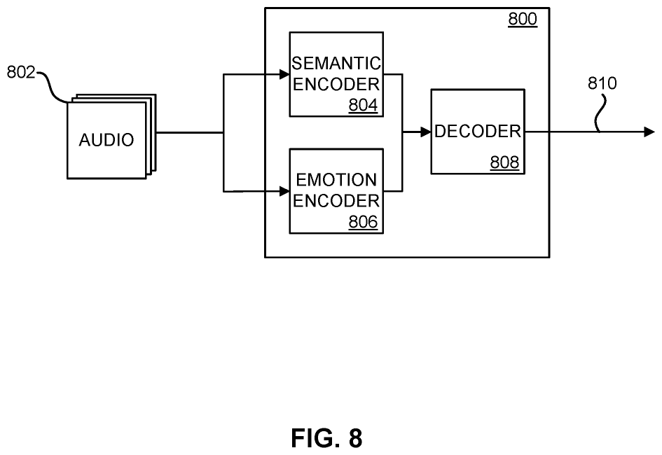

In some implementations, the emotion classifier 710 is configured to generate feature vectors using one or more neural networks trained and fine-tuned with training data including audio samples including speech content with ground-truth feature vectors representing emotional characteristics of the speech content. In some implementations, the emotion classifier 710 can be trained with a model trainer such as the emotion classifier trainer 800 shown in FIG. 8. In some implementations, the one or more neural networks can include one or more convolutional layers, pooling layers, and fully connected layers. The one or more neural networks can be trained and fine-tuned using one or more loss functions and one or more training and fine-tuning techniques such as unsupervised learning, semi-supervised learning, supervised learning, transfer learning, backpropagation, Adam optimization, reinforcement learning, and the like. The foregoing implementations are not intended to be limiting and other emotion classification arrangements are possible.

The emotion classifier trainer 800 can be configured to determine a set of parameters for the emotion classifier 710. The emotion classifier trainer 800 is configured to determine the set of parameters for the emotion classifier 710 using a speech emotional disentanglement technique. For example, as shown in FIG. 8, the emotion classifier trainer 800 can be configured to receive audio signals 802 that include speech content and ground-truth emotional information, encode semantic information of the speech content, encode emotional information of the speech content, concatenate the encoded semantic information and the encoded emotion information, and decode the concatenated information into reconstructed audio signals 810. The reconstructed audio signals 810 can be compared to the audio signals 802 to determine the set of parameters.

In some implementations, the emotion classifier trainer 800 includes a semantic encoder 804 configured to encode the semantic information of the speech content, an emotion encoder 806 configured to encode the emotion information of the speech content, and a decoder 808 configured to concatenate the encoded semantic and emotion information and decode the concatenated information. The semantic encoder 804 can be configured to encode the semantic information using a machine learning model such as the CTC-attention model. Additional information for the CTC-attention model is found in “Joint CTC-Attention based End-to-End Speech Recognition using Multi-task Learning” by Kim et al., published in the 2017 IEEE International Conference on Acoustics, Speech, and Signal Processing (ICASSP), the entire contents of which are hereby incorporated by reference as if fully set forth herein. The emotion encoder 806 can be configured to encode the emotion information using one or more neural networks. In some implementations, the one or more neural networks of the emotion encoder 806 can include one or more two-dimensional convolutional layers and one or more fully connected layers. The decoder 808 can also be configured to decode the concatenated information using one or more neural networks. In some implementations, the one or more neural networks of the decoder 808 can include one or more long short-term memory (LSTM) layers and one or more fully connected layers. The foregoing implementations are not intended to be limiting and other encoding and decoding arrangements are possible.

In some implementations, to determine the set of parameters, the reconstructed audio signals 810 can be compared to the audio signals 802 using loss functions. For example, the loss functions can include a reconstruction loss function configured to determine the distance between a reconstructed audio signal and an input audio signal and a classification loss function configured to determine the distance between encoded emotion information generated by the emotion encoder 806 and the ground-truth emotion information included in the audio signals 802. A total loss for the emotion classifier trainer 800 can be determined by combining the reconstruction loss function and the classification loss function. In some implementations, the reconstruction loss function and the classification loss function can be combined by concatenating, adding, and/or averaging the results of each function. In some implementations, hyperparameters can be selected and the total loss can be calculated. The set of parameters can be determined by maximizing or minimizing the total loss. The hyperparameters can be selected to control the behavior of the emotional classifier 710. For example, if the total loss is not maximized or minimized, the hyperparameters can be adjusted and total loss can be calculated based on the adjusted hyperparameters. As part of the training, techniques such as Adam optimization, backpropagation, random feedback, Direct Feedback Alignment (DFA), Indirect Feedback Alignment (IFA), Hebbian learning, and the like can be used to determine the set of model parameters to minimize or maximize the total loss function.

The decoder component 712 includes a mapper 714 configured to map the continuous latent space generated by the encoder component 702 to a discrete latent space. The discrete latent space can represent one or more motion characteristics of a subject of the avatar. The mapper 714 is configured to generate the discrete latent space by dividing the continuous latent space into segments, encoding the segments, and mapping each encoded segment to a discrete representation of the discrete latent space.

In some implementations, the mapper 714 is configured to map the continuous latent space generated by the encoder component 702 to a discrete latent space using one or more neural networks trained and fine-tuned with training data including videos labeled with ground-truth latent spaces. In some implementations, the one or more neural networks can include one or more TDNNs and one or more Gumbel-SoftMax layers. In these implementations, the one or more TDNNs can divide the continuous latent space into segments using a sliding window operation such that each window represents one or more frames of the video and encode the segments and the one or more Gumbel-SoftMax layers can map each encoded segment to a discrete representation of the discrete latent space. The one or more neural networks can be trained and fine-tuned using one or more loss functions and one or more training and fine-tuning techniques such as unsupervised learning, semi-supervised learning, supervised learning, transfer learning, backpropagation, Adam optimization, reinforcement learning, and the like. The foregoing implementations are not intended to be limiting and other mapping arrangements are possible.

The decoder component 712 also includes a combiner 716 configured to combine the feature vector generated by the emotion classifier 710 with the discrete latent space. In some implementations, the combiner 716 is configured to combine the feature vector generated by the emotion classifier 710 with the discrete latent space by concatenating, adding, and/or averaging the feature vector generated by the emotion classifier 710 and the discrete latent space.

The decoder component 712 also includes a geometry encoder 718 configured to generate a feature vector from the image 720. The feature vector generated by the geometry encoder 718 can represent geometrical features of the image 720. The feature vector can be multi-dimensional. In some implementations, the geometrical features can represent a geometry of the subject of the image 720 and a scale of the subject of the image 720.

In some implementations, the geometry encoder 718 is configured to generate feature vectors using one or more neural networks trained and fine-tuned with training data including images labeled with ground-truth feature vectors representing geometrical features of the images. In some implementations, the one or more neural networks can include one or more activation layers. The one or more neural networks can be trained and fine-tuned using one or more loss functions and one or more training and fine-tuning techniques such as unsupervised learning, semi-supervised learning, supervised learning, transfer learning, backpropagation, Adam optimization, reinforcement learning, and the like. The foregoing implementations are not intended to be limiting and other geometry encoding arrangements are possible.

The decoder component 712 also includes a decoder 722 configured to decode the combined feature vector generated by the emotion classifier 710 and the discrete latent space and decode the feature vector generated by the geometry encoder 718 into the coefficients 724. The coefficients 724 can represent learned facial expressions, learned emotional characteristics, and learned motions (e.g., rotation and translation) of the subject of the avatar.

In some implementations, the decoder 722 is configured to generate the coefficients 724 using one or more neural networks trained and fine-tuned with training data including videos labeled with ground-truth coefficients representing facial expressions, emotional characteristics, and motion features of subjects of the videos. In some implementations, the one or more neural networks can include one or more activation layers and one or more LSTM layers. The one or more neural networks can be trained and fine-tuned using one or more loss functions and one or more training and fine-tuning techniques such as unsupervised learning, semi-supervised learning, supervised learning, transfer learning, backpropagation, Adam optimization, reinforcement learning, and the like. The foregoing implementations are not intended to be limiting and other decoding arrangements are possible.

In some implementations, the reactor 626 can be fine-tuned using a discriminator (not shown) and a generative adversarial network (GAN) loss. The discriminator can be configured to fine-tune the reactor 626 to improve the representation of the emotional characteristic of the subject of the video 700. To restate, the discriminator can be configured to fine-tune the reactor 626 to improve the representation of the emotional characteristic of the subject of the video 700 beyond a positive emotion, a neutral emotion, and a negative emotion (e.g., an emotional characteristic between a positive emotion and a neutral emotion and an emotional characteristic between a neutral emotion and a negative emotion).

During fine-tuning of the reactor 626, the discriminator can be configured to receive the coefficients 724 decoded by the decoder 722 and generate labels for the coefficients 724. The labels can include a set of true labels representing one or more true emotions and a set of false labels representing one or more fake emotions. The labeled coefficients can be input into the reactor 626 to generate a set of test coefficients. The set of test coefficients can be compared to the labeled coefficients using a generative adversarial network (GAN) loss function. Parameters of the reactor 626 can be adjusted by maximizing the GAN loss. The set of test coefficients can be input into the discriminator to generate labeled coefficients. The labeled coefficients can be compared to the set of test coefficients using a discriminative loss function. Parameters of the discriminator can be adjusting by minimizing the discriminative loss. As part of the fine-tuning, techniques such as Adam optimization, backpropagation, random feedback, Direct Feedback Alignment (DFA), Indirect Feedback Alignment (IFA), Hebbian learning, and the like can be used to determine the adjust the parameters of the reactor 626 and discriminator to minimize or maximize the GAN and discriminative loss functions.

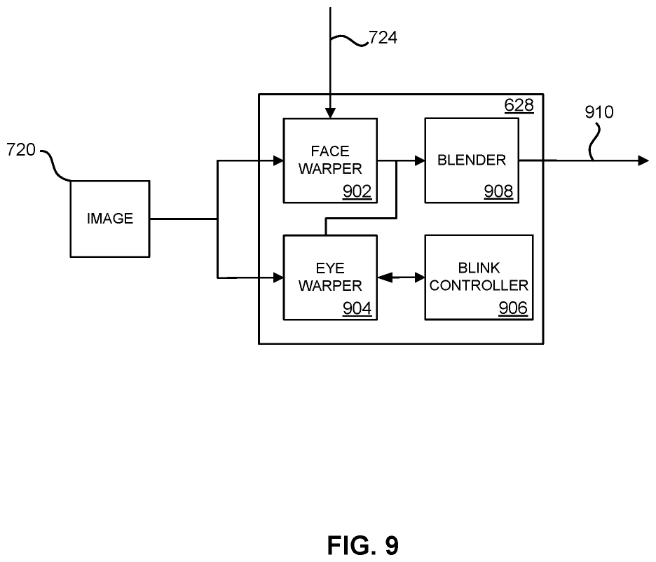

FIG. 9 is a simplified block diagram of a renderer such as renderer 628 of the avatar generator 612. The renderer 628 includes a face warper 902, an eye warper 904, a blink controller 906, and a blender 908. The renderer 128 is configured to receive the image and the coefficients as inputs and generate the avatar 910 by warping the image into warped frames based on the coefficients and blending the warped frames.

The face warper 902 is configured to receive the image and the coefficients and generate first warped frames. The first warped frames generated by the face warper 902 can represent visual features of the subject of the avatar. A first warped frame of the first warped frames can be generated for each frame of the video. In some implementations, the visual features can represent one or more facial expressions and motions (e.g., rotation and translation) of the subject of the avatar. In some implementations, each warped frame generated by the face warper 902 can depict a subject with their eyes opened. The face warper 902 is configured to generate warped frames from the image by using the coefficients to map or resample pixels of the image to pixels of a warped frame. For example, the coefficients can be used by a warping function of the face warper 902 to change the facial expression of the subject of the image to a target facial expression of the subject of the avatar.

In some implementations, the face warper 902 is configured to generate warped frames using one or more neural networks trained and fine-tuned with training data including images and their corresponding warped frames. In some implementations, the one or more neural networks can include one or more one-dimensional and two-dimensional convolutional layers, one or more adaptive instance normalization (AdaIN) layers, and one or more activation layers. In these implementations, a one-dimensional convolutional layer, an AdaIN layer, and a LeakyReLu layer can be configured to receive the image and the coefficients and generate an output by concatenating the outputs of the one-dimensional convolutional layer, the AdaIN layer, and the LeakyReLu. The output can be an embedding that represents three-dimensional and style features of the image. Also, a two-dimensional convolutional layer, an AdaIN layer, and a LeakReLu layer can be configured to receive the output and generate the warped frames. The one or more neural networks can be trained and fine-tuned using one or more training and fine-tuning techniques such as unsupervised learning, semi-supervised learning, supervised learning, transfer learning, backpropagation, Adam optimization, reinforcement learning, and the like. The foregoing implementations are not intended to be limiting and other face warping arrangements are possible.

The eye warper 904 is configured to receive the image, the coefficients, and an eye blink control parameter, and generate one or more second warped frames. A second warped frame generated by the eye warper 904 can represent visual features of the eyes of the subject of the avatar. A second warped frame can be generated a rate determined by the eye blink control parameter. In some implementations, the visual features can represent an eye open feature or eye closed feature for the subject of the avatar. In some implementations, each warped frame generated by the eye warper 904 can depict a subject with their eyes closed. The eye warper 904 is configured to generate warped frames from the image by using the coefficients and the eye blink control parameter to map or resample pixels of the image to pixels of a warped frame. For example, the coefficients and the eye blink control parameter can be used by a warping function of the eye warper 904 to change an eye-opening state of the subject of the image from an open state to a closed state.

In some implementations, the eye warper 904 is configured to generate warped frames using one or more neural networks trained and fine-tuned with training data including images and their corresponding warped frames. In some implementations, the one or more neural networks can be configured as the one or more neural networks of the face warper 902. In other implementations, the one or more neural networks can include one or more convolutional layers and activation layers. The one or more neural networks can be trained and fine-tuned using one or more training and fine-tuning techniques such as unsupervised learning, semi-supervised learning, supervised learning, transfer learning, backpropagation, Adam optimization, reinforcement learning, and the like. The foregoing implementations are not intended to be limiting and other eye warping arrangements are possible.

The blink controller 906 is configured to generate the eye blink control parameter. The eye blink control parameter generated by the blink controller 906 can represent an eye open state and an eye closed state. For example, when the eye blink control parameter is set to the eye open state, the eye blink control parameter can represent a subject with their eyes opened. In another example, when the eye blink control parameter is set to the eye closed state, the eye blink control parameter can represent a subject with their eyes closed. In some implementations, the blink controller 906 can be configured to generate the eye blink control parameter using a blinking control model. The blinking control model can be configured to receive a blink flag and an interval rate and generate a sequence of eye blink control parameters. The sequence of eye blink control parameters can represent the frames of the first warped frames that should be replaced with a second warped frame. For example, the sequence of eye blink parameters can represent that first warped frames W₁, W₁₂, W₁₄, W₂₁ should be replaced with a second warped frame. In some implementations, the blink flag can be set to 0 indicating an eye open state or 1 indicating an eye closed state. The blink flag can be randomly set to 0 or 1 or based on an input received from a user. The interval rate can represent the interval for setting the blink rate. In some implementations, the blink rate can be set once per interval. The interval rate can be determined or derived from the number of frames of the video. In some implementations, the interval rate can be a multiple of the frame rate of the video. For example, for a 30 second video having a frame rate of 30 frames per second, the interval rate can be set at 10 frames and a blink flag can be set once every 10 frames (e.g., an eye open or eye closed state can be set once every 10 seconds).

In some implementations, the blinking control model is configured to generate the sequence of blink control parameters using one or more machine learning models trained and fine-tuned with training data including videos depicting subjects blinking at various rates. The one or more machine learning models can be trained and fine-tuned using one or more training and fine-tuning techniques such as unsupervised learning, semi-supervised learning, supervised learning, transfer learning, backpropagation, Adam optimization, reinforcement learning, and the like. The foregoing implementations are not intended to be limiting and other blinking control models are possible.

The blender 908 is configured to generate the avatar 910 by blending the first warped frames and the one or more second warped frames. In some implementations, the blender 908 can be configured to generate an eye mask from a frame of the first warped frames. The eye mask can represent an orthographic projection from deleted eye region vertices in the frame. In some implementations, the blender 908 can be configured to blend the first warped frames and the one or more second warped frames by masking a frame of the first warped frames with the eye masking and blending a frame of the one or more warped frame with the masked first warped frames.

In some implementations, the blender 908 is configured to generate avatars using one or more neural networks trained and fine-tuned with training data including images and their corresponding warped frames. In some implementations, the one or more neural networks can include one or more two-dimensional convolutional layers, one or more AdaIN layers, and one or more activation layers. The one or more neural networks can be trained and fine-tuned using one or more training and fine-tuning techniques such as unsupervised learning, semi-supervised learning, supervised learning, transfer learning, backpropagation, Adam optimization, reinforcement learning, and the like. The foregoing implementations are not intended to be limiting and other blending arrangements are possible.

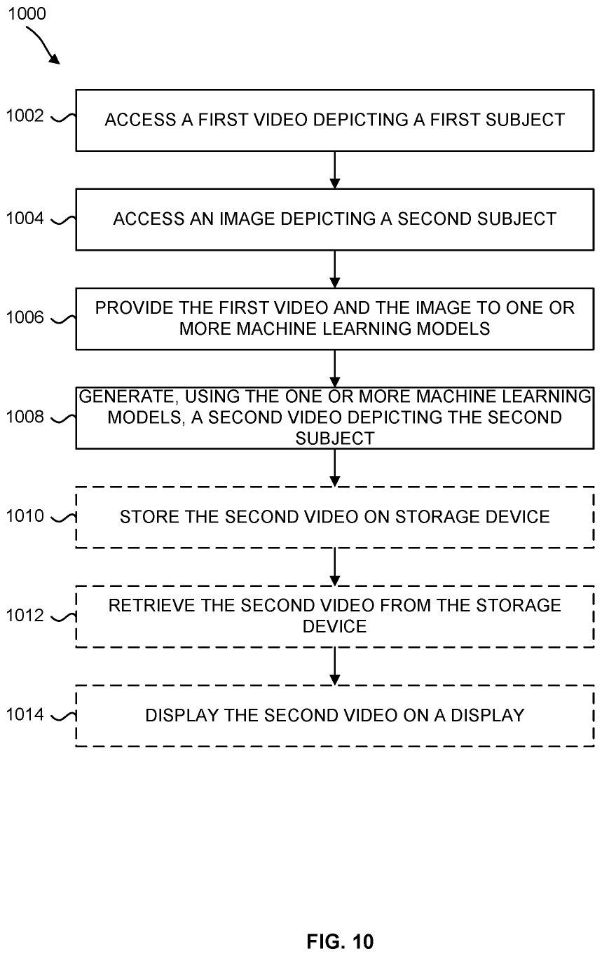

FIG. 10 illustrates an example of a process for generating a video depicting a virtual character. In some implementations, the process 1000 can be implemented by a system or computing device such as the system 200 and computing device 202 shown in FIG. 2. Additionally, the process 1000 can be implemented in software or hardware or any combination thereof.

At block 1002, a first video depicting a first subject is accessed. In some implementations, the first video includes an audio component that corresponds to speech spoken by the first subject. In some implementations, the first video is accessed from the computing device and/or a first video providing entity such as the speaker video providing entity 220.

At block 1004, an image depicting a second subject is accessed. In some implementations, the image is accessed from the computing device and/or an image providing entity such the listener image providing entity 218.

At block 1006, the first video and the image are provided to one or more machine learning models. In some implementations, the one or more machine learning models include one or more transformer-based models, one or more GAN models, or a combination thereof. In some implementations, the one or more machine learning models can be trained and fine-tuned using training data that includes labeled videos and images. The one or more machine learning models can be trained and fine-tuned by iteratively using the one or more machine learning model to make predicts from the labeled videos and images and comparing, using one or more loss functions, the results of the predictions to the labeled videos and images.

At block 1008, a second video depicting the second subject is generated using the one or more machine learning models. In some implementations, blinking performed by the second subject is responsive to at least one of the speech spoken by the first subject, a facial expression of the first subject, and a head pose motion of the first subject. In some implementations, generating the second video includes: generating, based on the first video, a plurality of feature vectors representing visual features and speech features of the first subject; generating, based on the plurality of feature vectors, an emotion vector representing one or more emotional characteristics of the first subject; generating, based on the plurality of feature vectors and the emotion vector, a discrete latent space representing one or more motion characteristics of the second subject; generating, based on the discrete latent space, a sequence of blink coefficients representing blinking performed by the first subject; and generating, based on the image, a mesh of the second subject, and the sequence of blink coefficients, the second video.

In implementations, the plurality of feature vectors is generated by extracting visual and speech features from the first video and combining respective feature vectors representing the visual and speech features. In some implementations, the plurality of feature vectors is a continuous-value space that represents cross-modal information derived from the first video that should be represented by the second subject in the second video such that the second subject can be responsive to the speaker (e.g., emotional value, utterance semantics, and response guidance).

In implementations, the emotion vector is generated by dividing the feature vectors of the plurality of feature vectors into segments using a sliding window operation such that each window represents one or more frames of the first video and encoding the segments into the generated emotion vector. The emotion vector can represent one or more emotional characteristics of the speaker (i.e., subject) of the first video. In some implementations, the one or more emotional characteristics can represent positive, neutral, and/or negative emotions or emotional states present within or that can be invoked by the video and audio components of the first video. In some implementations, the emotion vector includes a series of one-hot vectors corresponding to the feature vectors of the plurality of feature vectors. For example, the emotion vector can include a one-hot vector for each feature vector included in the plurality of feature vectors. In some implementations, a positive emotion of the subject of the first video can be represented as the one-hot vector [1, 0, 0], a neutral emotion of the subject of the first video can be represented as the one-hot vector [0, 1, 0], and a negative emotion of the subject of the first video can be represented as the one-hot vector [0, 0, 1]. As such, by including a series of one-hot vectors, the emotion vector can represent any positive, neutral, and/or negative emotions or emotional states exhibited or represented by the subject of the first video.

In some implementations, the discrete latent space is generated by processing a base space that includes one-hot vectors calculated from the plurality of feature vectors. In some implementations, the base space is a three-dimensional T×H×V-dimensional latent space in continuous space, where T represents length of the first video in frames, H is the number of latent classification heads, and V is the number of categories. In some implementations, the base space can be calculated from the plurality of feature vectors using a Gumbel-Softmax function. The base space can be processed into a transformed space by taking a dot product of the base space and each coefficient of the emotion vector to generate sub-base spaces, concatenating the sub-base spaces to generate an intermediate base space, and expanding the dimensions of the intermediate base space to generate the transformed space by multiplying the V dimension of the intermediate base space by the number of emotion categories (e.g., N emotion categories) in represented by the emotion vector. In some implementations, the transformed space is a three-dimensional T×H×NV-dimensional latent space in continuous space. The discrete latent space can be calculated by computing the argument maximum on the transformed space where codeword values of the discrete latent space can be in the range of {v′_{1:T,1:H}|v′_{i,j}∈[1, 2, . . . , NV]}. In some implementations, sets of emotion-coupled motion coefficients (e.g., β_{pred}(t), p_{pred}(t)) can generated from the discrete latent space. The sets of emotion-coupled motion coefficients can represent learned emotional facial expressions and emotional head pose motions performed by the speaker of the first video.

In some implementations, the sequence of blink coefficients representing blinking performed by the first subject is generated by decoding the discrete latent space. In some implementations, the sequence of blink coefficients can represent the learned blink sequence performed by the speaker over the duration t (e.g., frames) of the first video. In some implementations, a blink coefficient of the sequence of blink coefficients can be a 1 or 0, with 1 representing that a blink is performed by the speaker over the duration t (e.g., a blink performed by the speaker in a frame of the first video) and 0 representing that no blink is performed by the speaker over the duration t (e.g., the speaker's eyes are open in a frame of the first video). As such, the sequence of blink coefficients can include a sequence of 1's and 0's representing frames of the first video in which the speaker blinks.

In some implementations, the second video is generated by using the sets of emotion-coupled motion coefficients and the sequence of blink coefficients to transform the mesh into a video mesh that includes a set of video mesh frames where each video mesh frame of the video mesh represents a transformation or transformed version of the second subject of the image. The mesh and the video mesh can be processed, and a second video can be generated based the processing.

In some implementations, the image mesh is generated based on features extracted from the image. The extracted features can represent visual and geometrical features of the image and the image mesh can be multi-dimensional where the number of dimensions is defined in-part by the number of visual and geometrical features being represented. In some implementations, the visual and geometrical features can include facial expression, a geometry, and a scale of the person, subject, or character depicted by the image. In some implementations, to generate the image mesh and the video mesh, tone or more image processing algorithms can be used to segment the image and one or more image processing algorithms can be used to map the segmented elements to mesh elements of the image mesh.

To generate the video mesh, the sets of emotion-coupled motion coefficients can be applied to the image mesh to generate a sequence of video mesh frames collectively forming the video mesh. In some implementations, a set of emotion-coupled motion coefficients of the sets of emotion-coupled motion coefficients can be used to transform the image mesh into a video mesh frame and, by using each set of emotion-coupled coefficients of the sets of emotion-coupled coefficients, the image mesh can be transformed into the sequence of video mesh frames. In some implementations, the video mesh represents the face expression, geometry, and scale of the person, subject, or character depicted by the image expressing and moving as represented by the facial expressions and head movement (e.g., rotation and translation) features of the speaker of the first video.

To control the blinking of the second subject (i.e., the virtual character), the sequence of blink coefficients can be analyzed to determine groups of blink frames in which the speaker of the first video (i.e., a speaker video) is blinking and groups of no-blink frames in which the speaker of the first video is not blinking. The emotion-coupled motion coefficients of the sets of emotion-coupled motion coefficients at the start frame and end frame of each group of blink frames are identified and then interpolated over half the length of time between the start frame and end frame of a respective group of blink frames to determine an interpolated emotion-coupled motion coefficients between the start frame and end frame of the respective group of blink frames. The interpolated emotion-coupled motion coefficients can represent a blink state of the speaker over the duration from the start frame to the end frame of the respective group. In generating the video mesh, the interpolated emotion-coupled motion coefficients can be linearly weighted, which can simulate an eyelid position of the virtual character at each timestamp for physical blink and/or emotional events around the eyes of the virtual character.

A set of sparse motion vectors can be generated by calculating differences in positions between keypoints of respective video mesh frames of the video mesh and corresponding keypoints of the image mesh. For example, a difference between keypoints positions in a respective video mesh frame of the video mesh and corresponding keypoint positions in the image mesh can be calculated to determine a movement amount and a movement direction of the keypoints in the respective video mesh frame with respect to the corresponding keypoints in the image mesh. The keypoints can be calculated using one or more keypoint detection algorithms. In some implementations, at least one keypoint detection algorithm can be based on a U-Net architecture. In some implementations, the set of sparse motion vectors can be calculated from the keypoints using a Jacobian matrix through deformation.

A set of occlusion maps, which can identify regions in the second video in which the content of those regions can be generated by warping portions of the image and those regions in which the content of those regions can be generated by inpainting, can be predicted. To predict the set of occlusion maps, a dense motion field, which facilitates aligning features encoded from the image to the facial pose of the speaker of the speaker video, can be calculated. In some implementations, the features can be aligned using a mapping function that correlates corresponding pixels in the image and frames of the speaker video. In some implementations, the dense motion field is computed using a convolutional neural network. Once the dense motion field is computed, for each keypoint, a heatmap is generated from the dense motion field where each heatmap localizes one or more regions where the transformations are most relevant. The set of occlusion maps can be predicted from the heatmaps by concatenating the heatmaps with the set of sparse motion vectors.

High-frequency features can be extracted from the image by learning facial transformation features and texture features from the image. In some implementations, one or more machine learning models (e.g., one or more neural networks) can be employed, which can be trained and fine-tuned with training data that includes pairs of high-quality images and low-quality images. The one or more machine learning models can be trained and fine-tuned using one or more training and fine-tuning techniques such as unsupervised learning, semi-supervised learning, supervised learning, transfer learning, backpropagation, Adam optimization, reinforcement learning, and the like.

To train and/or fine-tune the one or more machine learning models, a set of first source images having a first quality level (e.g., a high-quality level) can be obtained and/or accessed. Each first source image of the set of first source images can be degraded to result in a set of second source images having a second quality (e.g., a low-quality level, where the low-quality level indicates that a respective image has a lower quality than a respective image of the set of first source images). The first source images can be degraded by adding noise, resizing the image (e.g., area, bilinear, bicubic), and compressing the image. The set of first source images and the set of second source images can be paired such each first source image is paired with a respect second source image. The training data can include pairs of first and second source images and, during training, the one or more machine learning models can learn to extract high-frequency features from source images. In some implementations, rather than degrading the first source images, super resolution processing can be applied to enhance the first source images. As such, training pairs can be formed with the first source images and the enhanced first source images. In some implementations, training examples can include a first source image, an enhanced source image, and a second source image. In this way, the one or more machine learning models can map features between images having varying levels of quality.

The second video can be generated using the set of occlusion maps and the high-frequency features. In some implementations, to generate the second video, a video frame of the second video is generated from an occlusion map of the set of occlusion maps and the high-frequency features and the generated video frames are combined to form the second video. To generate the video frames, a mapping function that can convert an occlusion map of the set of occlusion maps and the high-frequency features into a video frame can be learned. In some implementations, to learn the mapping function, one or more machine learning models (e.g., one or more deep convolutional networks), which can be trained and fine-tuned with training data that includes videos labeled with ground-truth occlusion maps and high-frequency features. The one or more machine learning models can be trained and fine-tuned using one or more training and fine-tuning techniques such as unsupervised learning, semi-supervised learning, supervised learning, transfer learning, backpropagation, Adam optimization, reinforcement learning, and the like.

To improve video generation, a plurality of loss functions can be employed. The plurality of loss functions can be divided into two categories with one category focusing on facial reconstruction and guiding the facial movement in sparse motion fields and the other category focusing on image quality. Examples of losses include facial structure losses, equivariance and deformation loss, perceptual loss, and GAN loss. The facial structure losses aim to ensure that both the expressions and poses in the synthesized facial images closely match those in the ground-truth images. These losses include various components, including keypoints loss, head pose loss, and facial expression loss. The keypoints loss refers to the L2 distance performed on the keypoints with corresponding depth information (i.e., spatial dimension), while both the head pose loss and facial expression loss utilize L1 distance over the estimated facial parameters. The equivariance loss ensures consistency of image-specific keypoints in 2D to 3D transformations and the deformation loss constrains the canonical space to the camera space transformation. The perceptual loss is calculated from the feature maps front activation layers of the model and the GAN loss is multi-resolution patch loss, where the discriminator predicts at the multiple patch-levels and a feature matching loss is used to optimize the discriminators.

The second subject depicted by the second video, which can be a virtual person or character, can appear to be listening to the speaker of the first video. In some implementations, the speaker of the first video can be speaking on a topic that is emotional and/or can invoke an emotion in a listener and the virtual character can appear to exhibit one or more emotions (e.g., by exhibiting motions, facial expressions, and/or eye blinks representative of one or more emotions) as if they are listening to speaker. In other words, the video can depict the second subject of the image exhibiting an emotional reaction, including eye blinks, that is responsive to the person or character speaking and/or the speech spoken by the person or character speaking of the first video.

Additionally, or alternatively, the second subject depicted in the second video can exhibit lifelike motions, facial expressions, emotions, reactions, behaviors, and/or other characteristics. In some implementations, the motions, facial expressions, emotions, reactions, behaviors, and/or other characteristics can be derived from and/or mimic the motions, facial expressions, emotions, reactions, behaviors, and/or other characteristics of one or more real-world and virtual people or characters. The second subject depicted by the second video can also perform an action, initiate an interaction, and/or be responsive to one or more real-world and virtual people or characters. For example, the second subject can exhibit one or more motions, facial expressions, emotions, reactions, behaviors, and/or other characteristics that are indicative of an action being performed (e.g., head moving with a particular facial expression), an interaction being initiated (e.g., pursing lips and beginning to speak), and/or a reaction by the avatar (e.g., furrowing eyebrows).

At optional blocks 1010, 1012, and 1014, the second video is stored on a storage device, is retrieved from the storage device, and displayed on a display.

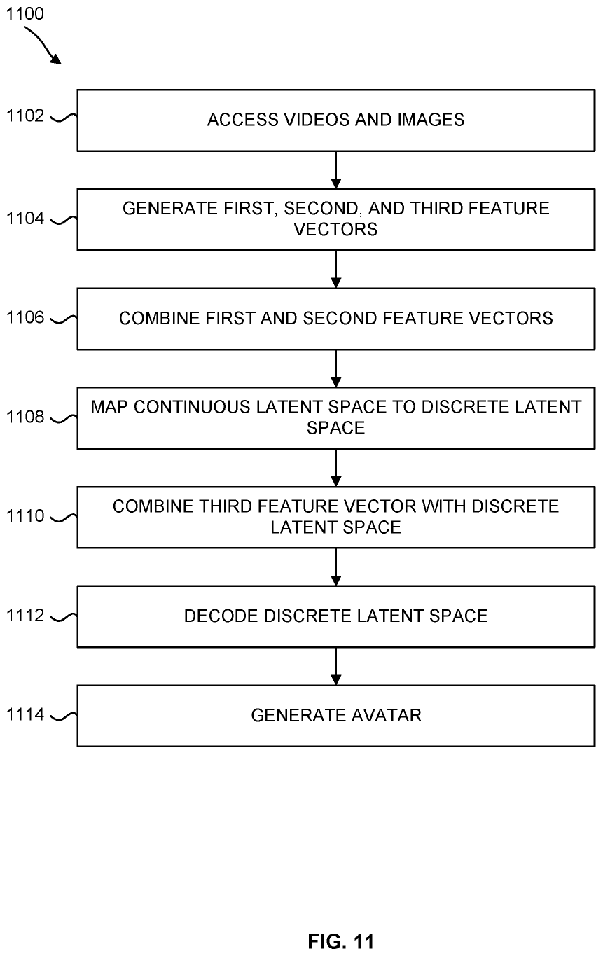

FIG. 11 illustrates an example process 1100 for generating an avatar according to some implementations of the present disclosure. In some implementations, the process 1100 can be implemented by a system or computing device such as the system 200 and computing device 202 shown in FIG. 2. Additionally, the process 1100 can be implemented in software or hardware or any combination thereof.

At block 1102, videos and images are accessed.

At block 1104, a first, second, and third feature vectors are generated from at least one video of the videos. The first feature vector can represent one or more visual features of the at least one video. The one or more visual features of the at least one video can include a facial expression or motion of a subject of the at least one video. The second feature vector can represent one or more audio features of the at least one video. The one or more audio features of the at least one video can include speech made by a subject of the at least one video. The third feature vector can represent an emotional characteristic of a subject of the at least one video.

At block 1106, the first feature vector is combined with the second feature vector. The combination of the first feature vector and the second feature vector can represent a continuous latent space for the at least one video.

At block 1108, the continuous latent space is mapped to a discrete latent space. The discrete latent space can represent one or more motion characteristics of a subject. Mapping the continuous latent space to the discrete latent space can include dividing the continuous latent space into segments, encoding each segment, and mapping each segment of the segments into a discrete representation of the discrete latent space.

At block 1110, the third feature vector is combined with the discrete latent space.

At block 1112, the discrete latent space is decoded into coefficients. Decoding the discrete latent space into the coefficients includes decoding one or more geometrical features of at least one image of the images.

At block 1114, an avatar is generated based on the coefficients. The avatar can include a sequence of frames depicting the subject and an emotional reaction of the subject. Generating the avatar can include warping the at least one image into warped images and controlling a blinking rate of the subject.

The systems and methods of the present disclosure may be implemented using hardware, software, firmware, or a combination thereof and may be implemented in one or more computer systems or other processing systems. Some embodiments of the present disclosure include a system including a processing system that includes one or more processors. In some embodiments, the system includes a non-transitory computer readable storage medium containing instructions which, when executed on the one or more processors, cause the system and/or the one or more processors to perform part or all of one or more methods and/or part or all of one or more processes disclosed herein. Some embodiments of the present disclosure include a computer-program product tangibly embodied in a non-transitory machine-readable storage medium, including instructions configured to cause the system and/or the one or more processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

What is claimed is:

1. A computer-implemented method comprising:
accessing, by a processor, a first video depicting a first subject, wherein the first video includes an audio component that corresponds to speech spoken by the first subject;
accessing, by the processor, an image depicting a second subject;
providing, by the processor, the first video and the image to one or more machine learning models;
generating, by the processor and using the one or more machine learning models, a second video depicting the second subject, wherein the second video depicts the second subject performing a blinking motion, and wherein the blinking motion performed by the second subject is responsive to at least one of the speech spoken by the first subject, a facial expression of the first subject, and a head pose motion of the first subject; and
storing, by the processor, the second video on a storage device.

2. The computer-implemented method of claim 1, wherein generating the second video comprises:
generating, by the processor and based on the first video, a plurality of feature vectors representing visual features and speech features of the first subject.

3. The computer-implemented method of claim 2, wherein generating the second video further comprises:
generating, by the processor and based on the plurality of feature vectors, an emotion vector representing one or more emotional characteristics of the first subject.

4. The computer-implemented method of claim 3, wherein generating the second video further comprises:
generating, by the processor and based on the plurality of feature vectors and the emotion vector, a discrete latent space, the discrete latent space representing one or more motion characteristics of the second subject.

5. The computer-implemented method of claim 4, wherein generating the second video further comprises:
generating, by the processor and based on the discrete latent space, a sequence of blink coefficients representing blinking performed by the first subject.

6. The computer-implemented method of claim 5, wherein generating the second video further comprises:
generating, by the processor and based on the image, a mesh of the second subject, and the sequence of blink coefficients, the second video.

7. The computer-implemented method of claim 1, further comprising:
retrieving, by the processor, the second video from the storage device; and
displaying, by the processor, the second video on a display.

8. A computer-implemented method comprising:
accessing, by a processor, plurality of videos and a plurality of images;
generating, by the processor, a first feature vector from at least one video of the plurality of videos, the first feature vector representing one or more visual features of the at least one video;
generating, by the processor, a second feature vector from the at least one video, the second feature vector representing one or more audio features of the at least one video;
combining, by the processor, the first feature vector with the second feature vector, the combination of the first feature vector and the second feature vector representing a continuous latent space for the at least one video;
mapping, by the processor, the continuous latent space to a discrete latent space, the discrete latent space representing one or more motion characteristics of a subject;
decoding, by the processor, the discrete latent space into a plurality of coefficients; and
generating, by the processor, an avatar based on the plurality of coefficients, the avatar comprising a sequence of frames depicting the subject and an emotional reaction of the subject.

9. The computer-implemented method of claim 8, wherein the one or more visual features of the at least one video comprises a facial expression or motion of a subject of the at least one video.

10. The computer-implemented method of claim 8, wherein the one or more audio features of the at least one video comprises speech made by a subject of the at least one video.

11. The computer-implemented method of claim 8, wherein mapping the continuous latent space to the discrete latent space comprises dividing the continuous latent space into a plurality of segments, encoding each segment of the plurality of segments, and mapping each encoded segment into a discrete representation of the discrete latent space.

12. The computer-implemented method of claim 8, further comprising:
combining, by the processor, a third feature vector with the discrete latent space, wherein the third feature vector represents an emotional characteristic of a subject of the at least one video.

13. The computer-implemented method of claim 8, wherein decoding the discrete latent space into the plurality of coefficients comprises decoding one or more geometrical features of at least one image of the plurality of images.

14. The computer-implemented method of claim 8, wherein generating the avatar based on the plurality of coefficients comprises warping at least one image of the plurality of images.

15. The computer-implemented method of claim 8, wherein generating the avatar comprises controlling a blinking rate of the subject.

16. One or more non-transitory computer-readable media storing computer-readable instructions that, when executed by a processing system comprising a processor, cause a system to perform operations comprising:
accessing, by the processor, a first video depicting a first subject, wherein the first video includes an audio component that corresponds to speech spoken by the first subject;
accessing, by the processor, an image depicting a second subject;
providing, by the processor, the first video and the image to one or more machine learning models;
generating, by the processor and using the one or more machine learning models, a second video depicting the second subject, wherein the second video depicts the second subject performing a blinking motion, and wherein the blinking motion performed by the second subject is responsive to at least one of the speech spoken by the first subject, a facial expression of the first subject, and a head pose motion of the first subject; and
storing, by the processor, the second video on a storage device.

17. The one or more non-transitory computer-readable media of claim 15, wherein generating the second video comprises:
generating, by the processor and based on the first video, a plurality of feature vectors representing visual features and speech features of the first subject.

18. The one or more non-transitory computer-readable media of claim 16, wherein generating the second video further comprises:
generating, by the processor and based on the plurality of feature vectors, an emotion vector representing one or more emotional characteristics of the first subject.

19. The one or more non-transitory computer-readable media of claim 17, wherein generating the second video further comprises:
generating, by the processor and based on the plurality of feature vectors and the emotion vector, a discrete latent space, the discrete latent space representing one or more motion characteristics of the second subject.

20. The one or more non-transitory computer-readable media of claim 18, wherein generating the second video further comprises:
generating, by the processor and based on the discrete latent space, a sequence of blink coefficients representing blinking performed by the first subject; and
generating, by the processor and based on the image, a mesh of the second subject, and the sequence of blink coefficients, the second video.
